(19) United States
(12) Patent Application Publication
(10) Pub. No.: US 2008/0234166 A1
(43) Pub. Date: Sep. 25, 2008

(54) Bleaching composition using multiple oxidizers

(76) Inventors: Perry L. Martin, Yuba City, CA (US); Roy W. Martin, Downers Grove, IL (US)

Correspondence Address: Roy W. Martin, 1440 Palmer, Downers Grove, IL, 60516, US

(21) Appl. No.: 11/228,985

(22) Filed: Sep. 16, 2005

Related U.S. Application Data
(60) Provisional application No. 60/611,085, filed on Sep. 17, 2004.

(51) Int. Cl. C11D 17/00; C11D 3/395

(52) U.S. Cl. 510/310; 510/309; 510/302

(57) ABSTRACT

Composition and method for bleaching are presented. The composition includes a reactor and an oxidizing agent. The reactor includes a core that contains an oxidizer reactant and generates dioxirane, percarboxylic acid, chlorine dioxide, hydroxyl radicals, and/or N-halo-amine when contacted by a main solvent. A reactor wall surrounds the core and controls diffusion of the main solvent to the core through the pores. The reactor wall has a substantially lower solubility in the main solvent than the oxidizer reactant and the generated product such that the reactor wall remains substantially intact until generation of the product is substantially complete. The oxidizing agent is in contact with the main solvent. The oxidizing agent, which may be a hypohalite donor, chlorine dioxide donor, halo-amine donor, percarboxylic acid donor, hydroxyl radical donor, persulfate(s), or a hydrogen peroxide donor, has an order of selectivity that is different from the product generated in the reactor.

### CROSS-REFERENCE TO RELATED APPLICATION

This application claims the benefit, under 35 USC §119(e), of U.S. Provisional Application No. 60/611,085 filed on Sep. 17, 2004.

### FIELD OF INVENTION

This invention relates generally to an oxidizing compound and more particularly to an oxidizing compound that is useful for bleaching applications.

### BACKGROUND

Bleaching is a well-known process for removing stains from various materials such as fabric. However, perhaps because only marginal progress has been made to bleaching technologies in the last several decades, the bleaching process that is currently used is far from perfect. For example, sodium hypochlorite, which is often used for white fabrics, may cause damage to dyes and fabrics when used in large quantities. As for peroxide salts (e.g., perborate, percarbonates, persulfates), which are usually used to bleach colored fabrics, they have limited effectiveness in cold water. To further improve the bleaching technology, precursors which react with hydrogen peroxide to form peracetic acid in alkaline conditions was developed. Even the peracetic acid, however, does not eliminate some tenacious stains. Thus, search continues for new technologies to improve the performance and efficacy of stain removal in detergent/bleach blends or bleaching formulations.

One of the improvements to bleaching is described in U.S. Pat. No. 4,064,062 (“the '062 patent”). The '062 patent discloses a stabilized activated percompound bleaching composition. The composition is a mechanical mixture of a bleaching percompound, an activator, a molecular sieve zeolite, and a higher fatty acid. For example, the composition may include sodium perborate tetrahydrate as the percompound, 2-[bis(2-hydroxyethyl)amino]-4,6-dichloro-s-triazine as the activator, an anhydrous type 4A synthetic molecular sieve zeolite, and myristic acid. The bleaching composition is made by mechanically mixing the various powdered constituents, preferably by tumbling at about room temperature. The resulting product is allegedly more stable on storage and more effective as a bleach in removing various stains from laundry than are similar products which do not contain the higher fatty acid.

WO 09923224A1 discloses a method of laundry bleaching using a persulfate compound in combination with a ketone, aldehyde or a halogen donor, whereby the item to be bleached is first contacted with an alkali solution, then contacted with an acidic solution containing the persulfate and precursors (e.g. ketone aldehyde or halogen).

U.S. Pat. No. 6,583,098 discloses a particulate detergent components comprising a bleaching agent and detergent compositions containing them are described. The invention relates to the problem of localised build-up of bleaching components and provides bleaching granules comprising no more than 50 wt. % of a particulate bleach component selected from bleach activators, pre-formed peracids, bleach catalysts and mixtures thereof, in addition to further detergent ingredients. The geometric mean particle diameter of the particulate bleach component is below 500 .mu.m. A method for making a bleach granule comprises in a mixing step, mixing the particulate bleach component with builders and/or surfactants and optionally other detergent ingredients and/or fillers in a high, moderate or low shear mixer to produce the bleach granules. Preferably, the bleach granules are produced in a moderate to low shear mixer. The granules or the combined detergent composition can be coated. The bleach particle is combined with other detergent agents. A coating can be applied to the granule or the detergent composition. Preferably any such coating agent will also have active properties useful in a detergent composition. One preferred coating agent is a surfactant or aqueous solution of surfactant. Upon addition to the wash water, the bleaching constituents are sufficiently dispersed before in-situ generation of the bleaching agent by the wash water, thereby preventing concentrated bleaching of the fabrics dye.

To overcome the limitation on in-situ generation of bleaching agents, current trends identify reactants that provide acceptable levels of conversion to the desired agent under alkaline conditions. For example, peracid is produced by reacting TAED and hydrogen peroxide under alkaline conditions to generate peracetic acid. Further more, U.S. Pat. No. 5,785,887 (“the '887 patent”) teaches using a peroxygen bleaching composition which includes approximately, by weight, a mixture of about 1 to about 75% of an inorganic peroxygen bleaching compound and about 1 to about 75% peroxygen ketalcycloalkanedione bleachant activator for bleaching laundry articles at room temperature. As illustrated in the data accompanying the '887 patent, other ketone donors enhance performance over persulfates alone. However, the preferred reactant apparently induces a higher conversion in the alkaline environment of the wash-water.

U.S. Pat. No. 5,720,897 describes a composition for use as a bleach catalyst. The composition includes at least one transition metal ion coordinated with at least one chelating ligand to form a complex capable of binding O₂H⁻. The ligand(s) should have at least two strong donor functional groups capable of coordinating with a single one of the transition metal ions in the complexes to form a six-member or larger ring. The complexes are capable of coordinating peroxide groups while the ligand functions to substantially prevent precipitation of hydroxides of the transition metal ions in aqueous alkaline solutions of the transition metal containing composition. A detergent-bleach composition comprising an effective amount of a peroxide bleaching agent and an effective amount of the bleach catalyst described above, and a bleaching agent composition comprising a peroxide compound present in an amount effective to impart a bleaching action and a catalyst present in an effective amount to promote the bleaching action of the peroxide compound comprising the transition metal composition described above are also disclosed, as well as a catalyst present in an effective amount to promote the bleaching action of peroxide compounds in a detergent-bleach composition comprising the transition metal composition described above.

While each of the methods above provide at least one benefits over just using a single oxidant during wash, the ability to effectively remove the stains falls short of the desired goal of effective stain removal. Furthermore, for many of the methods (e.g., WO 09923224A1), there is a tradeoff between convenience and effectiveness because multiple steps with different oxidizers are needed for improved bleaching effect.

### BRIEF DESCRIPTION OF THE DRAWINGS

FIGS. 1A, 1B, and 1C are schematic illustrations of the reactor wall during a reaction.

FIGS. 2A, 2B, 2C, and 2D show different stages of a reactor undergoing a reaction.

FIG. 3 is a schematic illustration that the reactor of the invention may be used to form various oxidizer products.

FIGS. 4A, 4B, 4C, 4D, 4E, and 4F show a solvent-activated reactor for generation of multiple oxidizer products under acid catalyzed conditions.

FIGS. 5A and 5B illustrate a solvent-activated reactor for generation of multiple oxidizer products under neutral to alkaline pH using stable polyester membrane reactor coating.

FIG. 6 shows the stability of PMPS in various alcohols which can be used to form suspensions or binders for formation of the core.

FIG. 7 shows the increase in viscosity provided by Carbopol® used to alter the rheology of the solution.

### SUMMARY

In one aspect, the invention is a composition for bleaching materials. The composition includes a reactor and an oxidizing agent. The reactor includes a core that contains an oxidizer reactant and generates dioxirane when contacted by a main solvent. The core is about 10-80 wt. % oxidizer reactant, 0.540 wt. % carbonyl donor, 0-30 wt. % binder, 0-30 wt. % pH buffering agent, and 0-50 wt. % filler. The reactor also includes a reactor wall surrounding the core and controlling diffusion of the main solvent to the core through the pores. The reactor wall has a substantially lower solubility in the main solvent than the oxidizer reactant and dioxirane such that the reactor wall remains substantially intact until generation of the dioxirane is substantially complete. The oxidizing agent is in contact with the main solvent. The oxidizing agent is a hypohalite donor, chlorine dioxide donor, halo-amine donor, percarboxylic acid donor, hydroxyl radical donor, persulfate(s), or a hydrogen peroxide donor. The oxidizing agent has an order of selectivity that is different from dioxirane.

In another aspect, the invention is a composition for bleaching materials in an alkaline environment. The composition includes a reactor and an oxidizing agent mixed with the reactor. The reactor has pores and includes a core and a reactor wall surrounding the core. The core contains an oxidizer reactant that generates dioxirane when contacted by a main solvent. The core is 10-80 wt. % oxidizer reactant, 0.5-40 wt. % carbonyl donor, 0-30 wt. % binder, 0-30 wt. % pH buffering agent, and 0-50 wt. % filler. The reactor wall controls the diffusion of the main solvent to the core through the pores. The reactor wall has a substantially lower solubility in the main solvent than the oxidizer reactant and dioxirane such that the reactor wall remains substantially intact until generation of the dioxirane is substantially complete. The oxidizing may be a hypohalite donor, chlorine dioxide donor, halo-amine donor, percarboxylic acid donor, hydroxyl radical donor, persulfate(s), or hydrogen peroxide donor. The oxidizing agent has an order of selectivity that is different from dioxirane.

In another aspect, the invention is a composition for bleaching materials that includes a reactor and an oxidizing agent. The reactor has pores and includes a core and a reactor wall surrounding the core. The core, which generates percarboxylic acid when contacted by a main solvent, is about 10-80 wt. % oxidizer reactant, 0.5-40 wt. % carboxylic acid donor, 0-30 wt. % binder, 0-30 wt. % pH buffer, and 0-50 wt. % filler. The reactor wall controls the diffusion of the main solvent to the core through the pores, and has a substantially lower solubility in the main solvent than the oxidizer reactant and percarboxylic acid such that the reactor wall remains substantially intact until the generation of the percarboxylic acid is substantially complete. The oxidizing agent is in contact with the main solvent. The oxidizing agent is selected from a hypohalite donor, chlorine dioxide donor, halo-amine donor, dioxirane donor, hydroxyl radical donor, persulfate(s), and hydrogen peroxide donor.

The invention also includes a composition for bleaching materials. The composition includes a reactor that has pores and an oxidizing agent in contact with the reactor. The reactor includes a core that generates percarboxylic acid when contacted by a main solvent, and a reactor wall surrounding the core and controlling the diffusion of the main solvent to the core through the pores. The core is about 10-80 wt. % oxidizer reactant, 0.5-40 wt. % carboxylic acid donor, 0-30 wt. % binder, 0-30 wt. % pH buffer, and 0-50 wt. % filler. The reactor wall has a substantially lower solubility in the main solvent than the oxidizer reactant and percarboxylic acid such that the reactor wall remains substantially intact until the generation of the percarboxylic acid is substantially complete. The oxidizing may be a hypohalite donor, chlorine dioxide donor, halo-amine donor, dioxirane donor, hydroxyl radical donor, persulfate(s), or a hydrogen peroxide donor.

The invention is also a composition for bleaching materials. The composition includes a reactor having pores and an oxidizing agent in contact with the main solvent. The reactor includes a core of reactants that react to generate chlorine dioxide when dissolved by a main solvent and a reactor wall surrounding the core and controlling the diffusion of the main solvent to the core through the pores. The core is about 10-80 wt. % of oxidizer reactant, 0.5-10 wt. % a halogen donor, 0.5-20 wt. % a chlorite donor, 0-30 wt. % binder, 0-30 wt. % pH buffering agent, and 0-50 wt. filler. The reactor wall has a substantially lower solubility in the main solvent than the oxidizer reactant and chlorine dioxide such that the reactor wall retains integrity until the reactants are substantially depleted. The oxidizing agent may be a hypohalite donor, dioxirane donor, halo-amine donor, percarboxylic acid donor, hydroxyl radical donor, persulfate(s), or a hydrogen peroxide donor.

The invention also includes a bleaching composition including a reactor having pores and an oxidizing agent in contact with the reactor. The reactor includes a core of reactants that react to generate chlorine dioxide when contacted by a main solvent, and a reactor wall surrounding the core and controlling the diffusion of the main solvent to the core through the pores. The core is about 10-80 wt. % oxidizer reactant, 0.5-10 wt. % a halogen donor, 0.5-20 wt. % a chlorite donor, 0-30 wt. % binder, 0-30 wt. % pH buffering agent, and 0-50 wt. filler. The reactor wall has a substantially lower solubility in the main solvent than the oxidizer reactant and chlorine dioxide such that the reactor wall retains integrity until the reactants are substantially depleted. The oxidizing agent in may be a hypohalite donor, dioxirane donor, halo-amine donor, percarboxylic acid donor, hydroxyl radical donor, persulfate(s), or a hydrogen peroxide donor.

The invention is also a bleaching composition that includes a reactor having pores and an oxidizing agent in contact with a main solvent. The reactor includes a core that generates hydroxyl radicals when contacted by the main solvent, and a reactor wall surrounding the core and controlling the diffusion of the main solvent to the core through the pores. The core is about 10-80 wt. % oxidizer reactant, 0.001-10 wt. % transition metal donor, 0-30 wt. % binder, 1-30 wt. % pH buffer, and 0-50 wt. % filler. The reactor wall has a substantially lower solubility in the main solvent than the reactants and the hydroxyl radicals such that the reactor wall remains substantially intact until the generation of the hydroxyl radicals is substantially complete. The oxidizing agent may be a hypohalite donor, dioxirane donor, halo-amine donor, percarboxylic acid donor, chlorine dioxide donor, persulfate(s), or a hydrogen peroxide donor.

The invention is also a composition for bleaching materials in an alkaline environment. The composition includes a reactor having pores and an oxidizing agent in contact with the reactor. The reactor includes a core that generates hydroxyl radicals when contacted by a main solvent and a reactor wall surrounding the core and controlling diffusion of the main solvent to the core through the pores. The core is about 10-80 wt. % oxidizer reactant, 0.001-10 wt. % transition metal donor, 0-30 wt. % binder, 1-30 wt. % pH buffer, and 0-50 wt. % filler. The reactor wall has a substantially lower solubility in the main solvent than the oxidizer reactant and the hydroxyl radicals such that the reactor wall remains substantially intact until the generation of the hydroxyl radicals is substantially complete. The oxidizing agent may be a hypohalite donor, dioxirane donor, halo-amine donor, percarboxylic acid donor, chlorine dioxide donor, persulfate(s), or a hydrogen peroxide donor.

The invention is also a composition for bleaching materials. The composition includes a reactor having pores, wherein the reactor includes a core that generates N-halo-amine when contacted by a main solvent. The core is surrounded by a reactor wall that controls the diffusion of the main solvent to the core through the pores. The core is about 10-80 wt. % oxidizer reactant, 0.5-10 wt. % halogen donor, 0.5-30 wt. % N-hydrogen-donor, 0-30 wt. % binder, 0-30 wt. % pH buffer, and 0-50 wt. % filler. The reactor wall has a substantially lower solubility in the main solvent than the oxidizer reactant and the N-halo-amine such that the reactor wall remains substantially intact until generation of the N-halo-amine is substantially complete. There is an oxidizing agent in contact with the main solvent. The oxidizing agent may be a hypohalite donor, dioxirane donor, hydroxyl radical donor, percarboxylic acid donor, chlorine dioxide donor, persulfate(s), or a hydrogen peroxide donor.

In yet another aspect, the invention is a composition for bleaching materials. The composition includes a first reactor that generates a first oxidizer product when contacted by a main solvent, and a second reactor physically mixed with the first reactor. The first reactor includes a first reactant surrounded by a first reactor wall, the first reactor wall allowing a main solvent to permeate into the first reactor and cause the first reactant to generate the first oxidizer product. The second reactor generates a second oxidizer product when contacted by the main solvent. The second reactor includes a second reactant surrounded by a second reactor wall, the second reactor wall allowing the main solvent to permeate into the second reactor and cause the second reactant to generate the second oxidizer product.

In yet another aspect, the invention is a composition for bleaching materials. The composition includes a reactor having pores and including a core that generates N-halo-amine when contacted by a main solvent, and a reactor wall that surrounds the core and controls the diffusion of the main solvent to the core through the pores. The core is about 10-80 wt. % oxidizer reactant, 0.5-10 wt. % halogen donor, 0.5-30 wt. % N-hydrogen-donor, 0-30 wt. % binder, 0-30 wt. % pH buffer, and 0-50 wt. % filler. The reactor wall has a substantially lower solubility in the main solvent than the reactants and the N-halo-amine such that the reactor wall remains substantially intact until generation of the N-halo-amine is substantially complete. There is an oxidizing agent in contact with the reactor, wherein the oxidizing agent may be a hypohalite donor, dioxirane donor, hydroxyl radical donor, percarboxylic acid donor, chlorine dioxide donor, persulfate(s), and a hydrogen peroxide donor.

In yet another aspect, the invention is a kit comprising reactors and instructions for using the reactors in combination with an oxidizing agent. The reactor includes a core containing an oxidizer reactant that generates one or more oxidizer product when contacted by a main solvent, and a reactor wall surrounding the core and controlling diffusion of the main solvent to the core through the pores. The reactor wall has a substantially lower solubility in the main solvent than the oxidizer reactant and the oxidizer product such that the reactor wall remains substantially intact until generation of the oxidizer product is substantially complete.

The invention may also be a kit including an oxidizing agent and instructions for using the oxidizing agent in combination with reactors. Each of the reactors includes a core containing an oxidizer reactant that generates one or more oxidizer product when contacted by a main solvent, and a reactor wall surrounding the core and controlling the diffusion of the main solvent to the core through the pores. The reactor wall has a substantially lower solubility in the main solvent than the oxidizer reactant and the oxidizer product such that the reactor wall remains substantially intact until generation of the oxidizer product is substantially complete.

The invention is also a kit including an oxidizing agent, reactors, and instructions for using the oxidizing agent with the reactors to achieve bleaching. Each of the reactors includes a core surrounded by a reactor wall. The core contains an oxidizer reactant that generates one or more oxidizer product when contacted by a main solvent. The reactor wall controls diffusion of the main solvent to the core through the pores. The reactor wall has substantially lower solubility in the main solvent than the oxidizer reactant to the oxidizer product such that the reactor wall remains substantially intact until generation of the oxidizer product is substantially complete. The oxidizer product is different from the oxidizing agent.

In yet another aspect, the invention is a method of bleaching a material. The method entails contacting a reactor and an oxidizing agent with a main solvent to form a bleach solution, wherein the reactor generates an oxidizer product that is different from the oxidizing agent, and wherein the oxidizer product has a different order of selectivity from the oxidizing agent. The bleach solution is placed in contact with the material. The oxidizer product is one or more of dioxirane, hydroxyl radical, peroxyacid, chlorine dioxide, and N-halo-amine, and the oxidizing agent is at least one of dioxirane, hydroxyl radical, N-halo-amine, hypohalite, chlorine dioxide and peroxyacid compound.

The invention is also a method of making a bleaching composition by forming a reactor that generates an oxidizer product upon contacting a main solvent, and providing an oxidizing agent to be added to the main solvent. The oxidizer product is at least one of dioxirane, hydroxyl radical, peracid, chlorine dioxide and N-halo-amine. The oxidizer product is different from the oxidizing agent and has a different order of selectivity from the oxidizing agent. The oxidizing agent is at least one of a dioxirane, hydroxyl radical, N-halo-amine, hypohalite, chlorine dioxide and a peracid compound.

The invention is also a method of bleaching a material. The method entails generating an oxidizer product by contacting a first reactor with a main solvent, the oxidizer product being at least one of dioxirane, hydroxyl radical, peracid, chlorine dioxide, and N-halo-amine. An oxidizing agent is generated by contacting a second reactor with the main solvent, wherein the oxidizing agent is different from the oxidizer product and has a different order of selectivity from the oxidizer product. The oxidizing agent is at least one of a dioxirane, hydroxyl radical, N-halo-amine, hypohalite, chlorine dioxide, and peracid compound.

The invention is also a method of bleaching a material. The method entails generating an oxidizer product by contacting a first reactor with a main solvent, the oxidizer product being at least one of dioxirane, hydroxyl radical, peracid, chlorine dioxide, and N-halo-amine. An oxidizing agent is generated in the main solvent by contacting a reactant with the main solvent, wherein the oxidizing agent is different from the oxidizer product and has a different order of selectivity from the oxidizer product. The oxidizing agent is at least one of a dioxirane, hydroxyl radical, N-halo-amine, hypohalite, chlorine dioxide, and peracid compound.

The invention is also a method of making a bleaching composition by forming a reactor that generates an oxidizer product upon contacting a main solvent, wherein the oxidizer product is at least one of dioxirane, hydroxyl radical, peracid, chlorine dioxide and N-halo-amine. An oxidizing agent is added to the main solvent, wherein the oxidizer product is different from the oxidizing agent and has a different order of selectivity from the oxidizing agent. The oxidizing agent is at least one of a dioxirane, hydroxyl radical, N-halo-amine, hypohalite, chlorine dioxide and a peracid compound.

### DETAILED DESCRIPTION OF THE PREFERRED EMBODIMENT(S)

The invention is particularly applicable to generation and release of oxidizers that have bleaching properties and it is in this context that the invention will be described. It will be appreciated, however, that the reactor, the method of making the reactor, and the method of using the reactor in accordance with the invention has greater utility and may be used for any other oxidizer product(s). Although the main solvent is described as water for clarity of illustration, the invention is not so limited.

“Reactor space” is a space that is defined by the outline of a reactor, and includes the space surrounded by the reactor wall, the reactor wall itself, and any pores or channels in the reactor wall. A “main solvent,” which is described as water in this disclosure although it is not so limited, may be any solvent that dissolves the reactant(s) in the core. When the reactor wall is “substantially intact,” the rate at which the main solvent permeates into the reactor is controlled by the size of the pores in the reactor wall. A “membrane” is a solid porous material. A “surrogate” describes the various acid, salt, and derivative forms of a particular compound. When a substance is “in contact with” another substance, the two substances could be directly touching or indirectly contacting each other through intervening substances.

An oxidizer has a certain “order of selectivity” as to what type of reactions and/or bonds they favor reacting with under the given conditions. The order of selectivity of hydrogen peroxide is altered by reaction with acetic acid to produce peracetic acid, which is an equilibrium product with residual hydrogen peroxide and acetic acid. Peracetic acid's ability to effectively decompose organics, bleach, and disinfect with substantially improved efficacy over the hydrogen peroxide illustrates the benefits resulting from the shift in reaction selectivity. Combining oxidizers with varying orders of selectivity enhances performance by allowing optimization of selective (targeted) oxidation reactions. U.S. patent application Ser. No. 10/878,899 illustrates that combining proper proportions of various oxidizers can significantly increase the rate of decomposition of compounds possessing COD. In contrast, using a single oxidizer requires substantially higher concentrations and often leads to subsequent drawbacks such as color and fabric damage.

A “non-solvent” is a carrier and void producing volatile liquid in which the polymer or coating material used in forming the reactor wall is insoluble. The term is also used to describe a liquid in which the oxidizer and/or oxidizable substance is insoluble. A solvent and a non-solvent that are used together are miscible. “Amphipathic” is intended to mean that a molecule has a polar and a nonpolar domain. A “polymer,” as used herein, includes a copolymer. A “critical level” is a predetermined amount of the oxidizer product that is generated by the chemical reaction in the reactor. The critical level may be, but does not have to be, defined by pH level. A plasticizer is a compound that alters the pliability and/or the hygroscopicity of the polymer. “Water,” as used herein, is not limited to pure water but can be an aqueous solution.

This invention is based on the discovery that selective combinations of oxidizers provide a synergistic effect to the bleaching process and substantially improve the efficacy of the bleaching process. Further, such selective combinations also improve the efficacy of the detergent/bleach composition that he oxidizer is combined with. The invention allows for traditional methods of applying the bleaching agent such as a powder or gel. The powder or gel can be combined in a detergent formulation and used during the pre-soak, filling or washing cycle. The invention allows different oxidizers to selectively target different bonds in the stains, thereby eliminating the multiple steps (e.g., using a stain remover before washing) required in the prior art.

Advantageously, the invention teaches a method of producing the bleaching agents in-situ to the wash or pre-wash cycle by employing solvent-activated reactors to produce and dispense the bleaching agents without need for prior dilution. The performance and efficacy of bleaching is substantially improved by utilizing in-situ generation in the controlled conditions provided by the solvent-activated reactors. The solvent-activated reactors induce high yield generation of the desired agent.

The difficulty in achieving the performance in bleaching operations is the result of a complex matrix of chemical compositions and bonds that are more resistant to oxidation from select oxidizers. An oxidizer such as N-chlorosuccinimide has been demonstrated to be very selective in breaking tryptophanyl peptide bonds, like those found in water insoluble protein stains. Combining such a compound with supporting compounds such as dioxirane, percarboxylic acid, chlorine dioxide, hydroxyl radicals and the like makes for an effective combination and provides for better and more consistent performance than using indiscriminate bleaching with higher concentrations of single oxidizers.

Another difficulty is the fact the oxidizers most effective at performing these functions have poor stability, and therefore generally require in-situ or point of use generation. To further complicate this issue, the alkaline environment of wash-water is not well suited for generating acid catalyzed oxidizers (e.g., hydroxyl radicals), or oxidizers favoring near neutral pH conditions (e.g., dioxirane). When the reactants are applied to produce these agents in-situ in alkaline wash-water, reduced yields, or less effective bleaching agents are produced which impairs performance. For these reasons, the agents are generally first produced separately and then applied to the wash water or the article to be bleached. This process entails multiple steps and utilizes higher concentration of reactants and/or bleaching agents.

To complicate the process further, many of the reactants used to produce the bleaching agents in-situ are not compatible. For example, N-chlorosuccinimide or chlorine dioxide utilizes hypochlorous acid to generate the bleaching agent, where bleaching compositions employing hydrogen peroxide to produce peracetic acid or singlet oxygen, counteract one another. Therefore, while the bleaching agents themselves may be compatible, the reactants used to produce them in-situ are not. Therefore, the types of bleaching agents that can be combined and produced in-situ are limited, or it requires multiple steps, including generation of the bleaching agents, followed by addition to the wash-water.

The bleaching composition of the invention allows multiple oxidizers to be used in combination, in a single step, without experiencing the above-mentioned disadvantages. One way to achieve effective bleaching using a combination of oxidizers is to use a solvent-activated reactor of the type described below. The solvent-activated reactor is stable when dry but generates a predetermined oxidizer product when placed in contact with water. The solvent-activated reactor may be placed in contact with water together with an oxidizing agent that is different from the oxidizer product that is generated in the reactor. For example, the solvent-activated reactor may use the oxidizing agent as one of the reactants for generating the oxidizer product, but use an excess amount of oxidizing agent. That way, there will be residual oxidizing agent available even after generation of the oxidizer product is substantially complete. Alternatively, a reactor that generates an oxidizer product may be used in combination with an oxidizing agent that is directly added to the water, for example in powder form.

In yet another alternative, a first reactor that generates the oxidizer product may be used in conjunction with a second reactor that generates the oxidizing agent. In another embodiment, a single reactor may be configured to generate multiple oxidizer product(s) and the oxidizing agent.

The disclosed bleaching compositions can be used directly in an aqueous solution to bleach a fabric or a harsh surface. Alternatively, the bleaching composition can be added to a cleaning composition such as a powdered laundry detergent, a nonaqueous laundry detergent, a scouring powder, a hard surface cleaning composition, a powdered automatic dishwashing composition, a non-aqueous automatic dishwashing composition, a hair bleach composition, a wound cleaning composition, a dental cleaning composition, a paper bleaching composition and a pre-spotter, and swimming pool treatment.

The compositions disclosed can be applied as a powder, formed into a convenient solid, or used as a viscous gel directly to the wash-water during the pre-wash or wash cycles. Furthermore, the compositions can be applied during the pre-soak phase prior to the wash cycle.

The in-situ generation of these powerful oxidants provides broad-spectrum oxidation thereby enhancing performance by allowing for optimized selectivity of reactions, while preventing the problems associated with indiscriminate oxidation resulting from higher dosages of indiscriminate oxidation.

### Exemplary Oxidizer Products

Some examples of oxidizers that can be used as reactants include peroxygen perborates, percarbonates, sodium peroxide, lithium peroxide, calcium peroxide, magnesium peroxide, urea peroxide, perphosphate, persilicate, monopersulfate, and persulfate. The oxidizers that are used as reactants are herein referred to as the “oxidizer reactants.” The oxidizers that are generated as a result of the first oxidizer's going through a chemical reaction are referred to as the “oxidizer products.” An “oxidizing agent” is a substance that is different from the oxidizer product that it is used in conjunction with, and may or may not be the same as the oxidizer reactant.

N-halo-amines, in particular N-halo-succinimide, are stable forms of chlorine that improve bleaching efficacy. N-halo-succinimides have improved selectivity for bonds like those found in tryptophanyl peptide bonds. Besides being able to effectively target selective classes of bonds to enhance selective bleaching applications, high selectivity has other benefits. N-halo-succinimide's ability to survive the organic soup making up cell fluids and external contaminants enhances its ability to perform its targeted function, which includes decomposing protein bonds (such as DNA) and fragments of water-insoluble proteins to smaller water-soluble sources of COD. Water-soluble COD is effectively decomposed with various oxygen radicals and peroxygen compounds. Halogenation reactions further enhance continuous breakpoint halogenation as disclosed in the prior art. This synergistic effect dramatically enhances the application's performance. The N-halo-amine family of compounds includes N-halo-sulfamates, N-halo-cyanurates, and N-halo-hydantoins, among others.

Hydroxyl radicals are powerful oxidizers that react with organic COD. The reaction between hydroxyl radicals and organic COD does not entail oxygen or halogen transfer. Rather, the hydrogen cleavage of hydrocarbons induces radical formation, followed by auto-catalytic decomposition thereby further fragmenting larger compounds.

Percarboxylic acids are affective at oxidizing organic COD. Used in bleaching and disinfection applications, oxidation occurs from oxygen substitution. The organic acid byproduct can be a stable acid (un-reactive, such as succinic acid) or reactive with other oxidizers.

Dioxirane is a powerful oxidizer used in bleaching as well as organic synthesis applications. It is also an effective antimicrobial agent. Oxygen substitution is the primary oxidation reaction.

Chlorine Dioxide is an effective disinfect, and is used in various bleaching applications. Through primary oxygen substitution, chlorine dioxide induces decomposition of many organic forms of COD.

### A Solvent-Activated Reactor

By utilizing the solvent-activated reactor compositions disclosed in the invention, these compounds can be effectively produced in-situ in high yield thereby enhancing the overall bleaching process as well has providing for improved bleaching efficacy of bleach and detergent/bleach compositions. Also, the invention allows for in-situ generation of multiple bleaching agents, thereby providing effective decomposition of stains by allowing for selective targeting of bleaching agents with specific bonds which comprise the stain.

Solvent-activated reactor technology comprises a core containing the primary oxidant, and at least one oxidizable substance, that when combined in an aqueous solution, produces an entirely new oxidizer. Favorable conditions are sustained by utilizing a reactor that surrounds the core, and remains intact until at least the core has been depleted. The reactor is comprised of a coating, which is permeable to the solvent (e.g. wash-water) into which the solvent-activated reactor is introduced, but restricts the core components from diffusing out through the pores of the reactor coating. The coating can be an agglomerate of colloidal particles such as that produced by meta-silicate in acid pH conditions, or can be a membrane, in which the porosity can be controlled during its formation to better control the diffusion rates. By restricting the diffusion rates of solvent to the core, and core components back to the bulk wash-water, the reactants inside the reactor have sufficient time to react under favorable conditions which are best suited to produce the desired bleaching agent. For example, hydroxyl radicals, hypohalites, N-halo-amines and the like favor acid catalyzed conditions. The alkaline conditions of wash-water used in laundry applications is not suitable to produce high yields of these agents.

To maximize the yield in a chemical reaction, it is usually preferable to start with high concentrations of reactants because the molar concentrations of the reactants determine the rate of reaction and the subsequent product yield. Therefore, adding reactants to a large body of water to be treated is not an effective way to generate the desired product in-situ. Adding the reactants to the water lowers the reactant concentrations, and the resulting conversion of the reactants to the desired product(s) is generally poor. Another factor to be considered is the side reactions. When generating an agent in-situ, the oxidizer reactant is often consumed in reactions other than those desired for the in-situ production of the oxidizer product. Therefore, adding the reactants to the water to be treated results in more reagent requirements, longer reaction time, and/or an overall decreased yield of the oxidizer product.

Furthermore, the chemical environment, such as pH, can adversely affect the in-situ production of the oxidizer product. For example, reactions that are acid catalyzed are not supported in alkaline conditions such as laundry wash water. By isolating the reactants and controlling the conditions inside the reactor, efficient generation of the oxidizer product(s) occurs regardless of the conditions external to the reactor.

When an oxidizer, such as potassium monopersulfate (PMPS), is added to water to convert sodium chloride to hypochlorous acid oxidizer product a hypohalite reaction, the conversion or yield is dependent on the molar concentrations of the reactants. As described above, however, adding a given amount of reactants to a large volume of water yields poor conversion to the oxidizer product. Furthermore, potassium monopersulfate is highly reactive with organic chemical oxygen demand (COD). Thus, upon being exposed to the bulk solution, the PMPS reacts with the COD and further reduces the concentration of PMPS that is available to induce the hypohalite reaction.

The solvent-activated reactor achieves a high yield of the oxidizer product by controlling the rate at which the reactants are exposed to water. More specifically, if the reactants were first exposed to a small volume of water and allowed to react to generate the oxidizer product, a high yield of the oxidizer product can be obtained because the reactant concentrations will be high. Then, the oxidizer product can be exposed to a larger volume of water without compromising the yield. The rate at which the reactants are exposed to water has to be such that the oxidizer product is generated in high-yield before more water dilutes the reactants. The invention controls the reactants' exposure to water by coating the reactants with a material that allows water to seep in and reach the reactants at a controlled rate.

Depending on the embodiment, the invention may be a reactor that is stable enough for storage and useful for generating high yields of products in-situ, product including oxidizers, biocides, and/or virucidal agents. A “soluble reactor” has walls that dissolve in the main solvent after the reaction has progressed beyond a certain point such that the concentration of the oxidizer product is equal to or greater than a predetermined critical level. The soluble reactor is stable when dry. When mixed with a main solvent (e.g., water), however, the coating material that forms the outer wall of the soluble reactor allows the solvent to slowly seep into the inside of the reactor and react with the core. The core of the soluble reactor contains one or more reactants that, when combined with the main solvent, react to generate an oxidizer product. Since the concentrations of the reactants are high within the soluble reactor, a high yield of the oxidizer product is achieved inside the reactor. After the generated amount of the oxidizer product reaches a critical level, the coating material dissolves or dissipates, releasing the oxidizer product into the bulk solvent body.

In some embodiments, the reactor of the invention is a “solvent-activated reactor” having a diameter or width in the range of 10-2000 μm. However, the reactor is not limited to any size range. For example, the reactor may be large enough to be referred to as a pouch or a tablet. A single reactor may be both a solvent-activated reactor and a soluble reactor at the same time. Furthermore, a reactor may have a soluble wall and a non-soluble wall.

The reactor of the invention includes a core and a reactor wall surrounding the core. There may be additional layers, such as a protective layer for shielding the core from the environmental elements. The core contains an oxidizer reactant, an oxidizable reactant, or both. The reactor wall has a lower solubility than the reactants in the core or the oxidizer product that is produced in the reactor. The reactor wall controls the diffusion of water into the reactor and restricts the diffusion of reaction components out of the reactor. The rate at which water seeps into the reactor and the rate at which the oxidizer product leaves the reactor are controlled oxidizer product the porosity of the reactor wall.

The invention includes a method of preparing a reactor, wherein the reactor produces high concentrations of one or more oxidizer products that are different from the reactants enclosed in the reactor. The method of the invention allows the production of compositions that are stable for storage and, upon activation by contact with the solvent, produce a different composition in a high yield. It is the intent of the disclosure to illustrate exemplary methods of use for the various compositions.

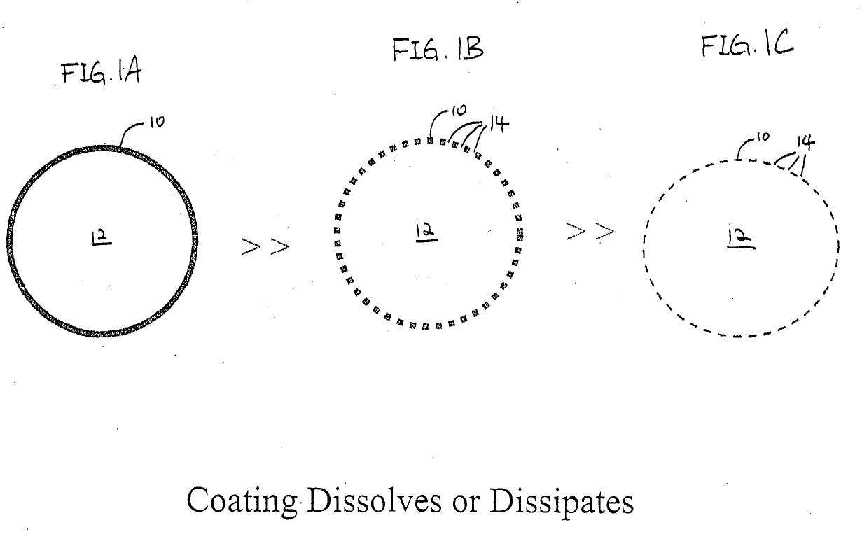

FIGS. 1A, 1B, and 1C are schematic illustrations of the reactor wall 10 of a-reactor 100 during a reaction. As shown in FIG. 1A, the reactor wall 10 is initially substantially solid, forming an reactor space 12 where reactants (not shown) can be placed. When the reactor wall 10 encounters water, it slowly forms cracks or fissures 14 in the reactor wall 10, as shown in FIG. 1B. The water seeps into the reactor 100 through the fissures 14, dissolves at least some of the reactants in the reactor space 12, and triggers a chemical reaction. Aside from the fissures 14, the reactor wall 10 remains substantially intact while the reactants react inside the reactor space 12 to generate the oxidizer product. However, once the reaction progresses to a critical level, the reactor wall 10 dissolves, as illustrated in FIG. 1C by the thinning of the reactor wall 10. The reactor wall 10 eventually dissipates into the water, releasing the oxidizer product into the body of water.

Details about the composition of the reactor wall 10 are provided below.

One way to control the timing of the disintegration of the reactor wall is to select a reactor wall 10 whose solubility is a function of pH. In this case, the critical level is a certain pH level where the reactor wall 10 becomes soluble. If the solubility of the reactor wall 10 is impaired by the pH of the internal and/or the external solution, and the pH of the internal solution changes as the reaction in the reactor space 12 progresses, the reactor wall 10 will not become soluble until a certain pH is reached in the reactor (i.e., the reaction has progressed to a certain point). The reactions may occur in the reactor space 12 or along the inner surfaces of the reactor wall 10.

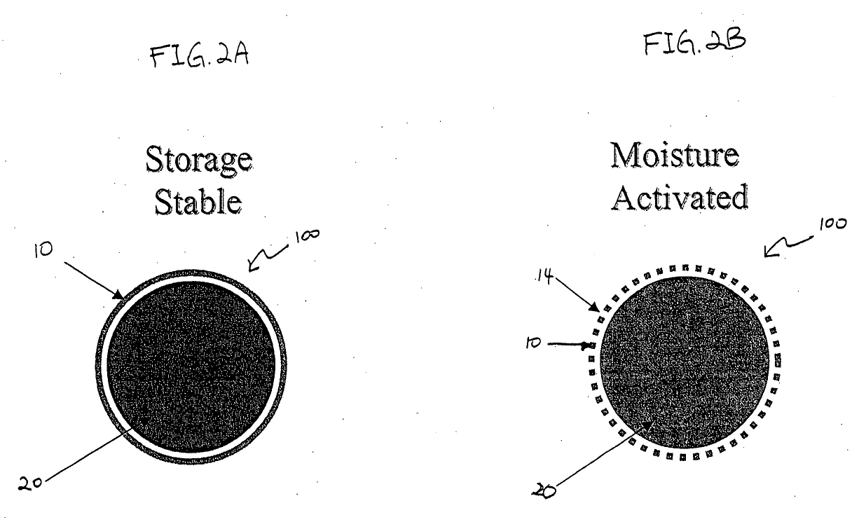

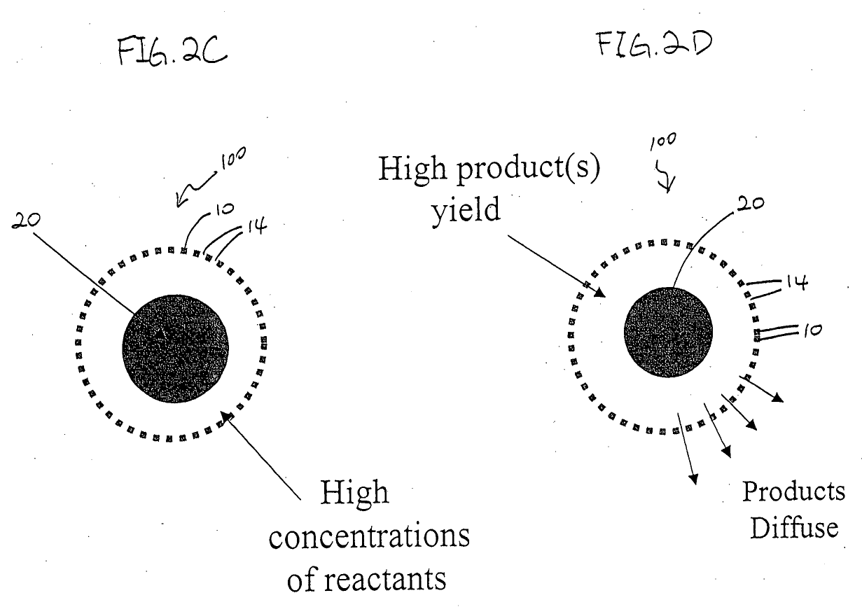

FIGS. 2A, 2B, 2C, and 2D show different stages of the reactor 100 undergoing a reaction. The reactor 100 has a core 20 in the reactor space 12. When in storage, the reactor wall 10 is intact and protects the core 20 from various environmental elements, as shown in FIG. 2A. When the reactor 100 is placed in the liquid to be treated, the reactor wall 10 begins to form the fissures 14 and the core 20 begins to dissolve, as shown in FIG. 2B. When dissolved, the components that form the core 20 become reactive and a chemical reaction begins. Since the amount of the water that permeates into the reactor space 12 is small, the components that form the core 20 (i.e., the reactants) remain high in concentration. As the chemical reaction progresses, the reactant concentration decreases, as shown by the decreasing size of the core 20 in FIG. 2C. When the concentration of the desired oxidizer product becomes high, the reactor wall 10 begins to disintegrate and the oxidizer product diffuses out of the reactor wall 10 into the water outside the reactor, as shown in FIG. 2D.

The reactant in the core may contain an oxidizing agent, such as a peroxygen compound. The peroxygen compound may be, for example, monopersulfate, percarbonate, perborate, peroxyphthalate, sodium peroxide, calcium peroxide, magnesium peroxide, or urea peroxide. As for the “oxidizable reactant,” which may also be present in the core, it usually reacts with the oxidizer reactant to produce one or more oxidizer products. The oxidizer products may include an oxidizer that is different from the oxidizer reactant. In some embodiments, the oxidizable reactant is a catalyst that is not consumed during its reaction with the oxidizer reactant. However, in some other embodiments, the oxidizable reactant is altered and consumed by the reaction with the oxidizer reactant.

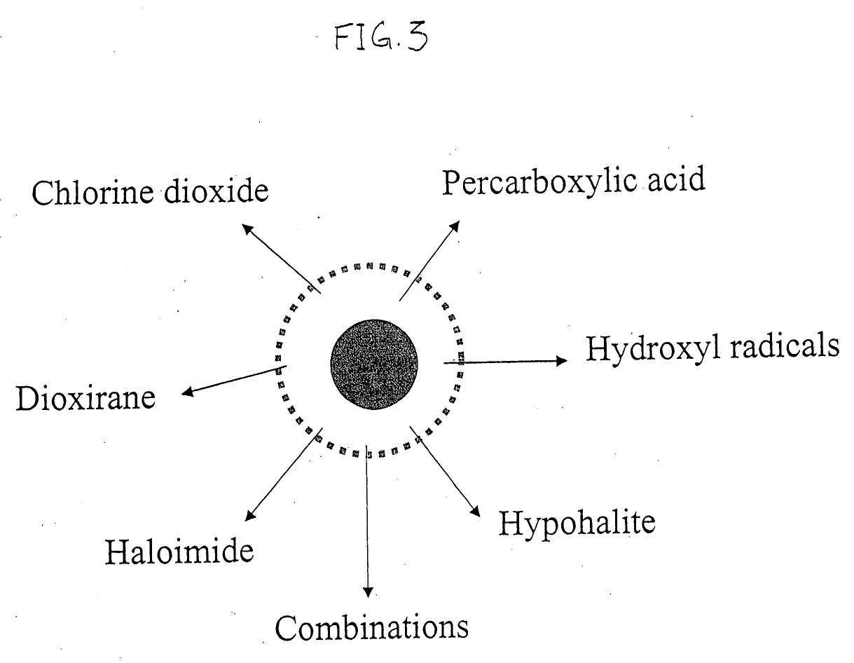

FIG. 3 is a schematic illustration that the reactor 100 may be used with any suitable reactions including but not limited to reactions that produce hypohalite, haloimide, dioxirane, hydroxyl radicals, percarboxylic acids, or chlorine dioxide. The reactor is useful for producing one or more of hypochlorous acid, hypochlorite, chlorine gas, hypobromous acid, hypobromite, bromine gas, N-halo-succinimide, N-halo-sulfamate, N-bromo-sulfamate, dichloro-isocyanuric acid, trichloro-isocyanuric acid, 5,5 dihalo dialkyl hydantoin, Hydroxyl radicals, oxygen radicals, peracids, and chlorine dioxide, and releasing the product into a body of water.

### 1) Reactor Core

Reactants are selected to induce the formation of the desired product(s). When determining the ratio of reactants, consideration should be given to the desired ratio of products. Single species generation of agent is achieved with proper optimization of reagent ratios.

High conversion of reactants and good stability of products is achieved by adding stabilizers and/or pH buffering agents to the mixture of reactants. For example, to produce N-haloimides (also called N-halo-amines) such as N-chlorosuccinimide, N-succinimide is added to a mixture containing PMPS and NaCl. Also, an organic acid (e.g., succinic acid) and/or inorganic acids (e.g., monosodium phosphate) may be applied to ensure that the pH of the reactant solution is within the desired range for maximum conversion to the haloimide.

The core includes reactants that, upon dissolution, induce the in-situ generation of the desired oxidizer product(s). For example, where the desired oxidizer product is a bleaching/oxidation agent, the reactant may be a peroxygen compound such as a persulfate, inorganic peroxide, alkyl peroxide, and aryl peroxide. The core can be formed into any useful size and shape, including but not limited to a granule, nugget, wafer, disc, briquette, or puck. While the reactor is generally small in size (which is why it is also referred to as the solvent-activated reactor), it is not limited to any size range.

Binders are compounds that are used to combine the components in the core and hold them together, at least until they are coated, to provide a homogenous mixture of reactants throughout the core. Binders may not be necessary in some embodiments. Many different types of compounds can be used as binders including polymers with hydrophobic and/or hydrophilic properties (e.g. polyoxyethylene alcohol, fatty acid esters, polyvinyl alcohol), fatty acids (e.g. myristic acid), alcohols (myristic alcohol), and polysaccharides such as chitosan, chitin, hydroxypropyl cellulose, hydroxypropyl methylcellulose and the like. The function of the binder is to provide an agglomerating effect without adding an undesirable amount of moisture so as to cause the reactants to dissociate and start reacting. In cases where solvent recovery apparatus is available during manufacturing, binder solvents can be used to promote better distribution of the binder as long as the solubility of the reactants in the binder solvent is low.

The binder may be a rheology-altering polymer/copolymer such as Carbopol® sold by BFGoodrich that is a family of polymer/copolymers comprised of high molecular weight homo- and copolymers of acrylic acid crosslinked with a polyalkenyl polyether. Rheology-altering polymers allow a wide range of core components to be combined by incorporating a non-solvent in the core. Either the oxidizer reactant or the oxidizable reactant is insoluble in the non-solvent. The presence of the non-solvent prevents activation of the components in the core, whereby the rheology-altering component binds the core components to provide a homogenous mixture. Depending on the embodiment, the non-solvent may become a part of the final composition, be partially removed, or be removed altogether. Since the non-solvent is usually not water, the final product may contain volatiles although it is substantially free of water (moisture). Sometimes, moisture may be used to enhance the formation of the agglomerate. However, in such cases, at least the oxidizer reactant should be coated to prevent its dissociation, the moisture should be well-distributed and used sparingly, and any moisture should be completely removed before long-term storage.

Fillers can be used or altogether omitted depending on the type of processing and the requirements of the use of the final product. Fillers are typically inorganic compounds such as various metal alkali salts and oxides, zeolites and the like. The fillers can enhance distribution of moisture when water is employed to enhance agglomeration.

A pH buffer, which is an optional component of the core, provides a source of pH control within the reactor. Even when alkaline water from laundry wash is used to dissolve the core, the pH buffers provide effective adjustment and control of the pH within the desired range to induce the desired reactions inside the reactor. PH buffers can be inorganic (e.g. sodium bisulfate, sodium pyrosulfate, mono-, di-, tri-sodium phosphate, polyphosphates, sodium bicarbonate, sodium carbonate, boric acid and the like). Organic buffers are generally organic acids with 1-10 carbons such as succinic acid.

Stabilizers are added when N-hydrogen donors are applied to generate N-haloimides in-situ. Examples of stabilizers include but are not limited to N-succinimide, N-sulfamate, isocyanuric acid, and the like. When stabilization is not required to generate these compounds, they can be omitted.

### 2) Core Configurations

Generally, the core composition is broken down as about 10-80 wt. % oxidizer reactant and about 1-20 wt. % oxidizable reactant, although there may be exceptions, as described above. The entire core is at least about 50 wt. % solids.

There are different configurations in which the core can be prepared, depending on the types of equipment available, the core composition, and the solubility characteristics of the core components.

A first configuration is a layered configuration wherein the different components form discrete layers. In this configuration, the oxidizable reactant is separated from the oxidizer reactant by a layer of a third component. This can be accomplished, for example, by spray coating or adding components in separate mixing stages, such as in a fluidized bed drier, to produce separate layers. When using this method, controlled diffusion rates oxidizer product the reactor coating is achieved to ensure that adequate reaction internal to the reactor happens prior to diffusion of the oxidizer product(s). The diffusion rates can be further controlled by arranging the layers such that the most soluble component makes up the innermost layer of the core.

A second configuration is a homogeneous core. In this configuration, the core components and the binder are combined and mixed to form a homogenous core. The binder can be any one or more of the compounds mentioned above, and one or both of the oxidizer reactant and the oxidizable reactant are immiscible with the binder. The mixing can be carried out in a blender/mixer, agglomerator, or a fluidized bed device. If there is moisture in the core, it can be either dried to remove any final moisture. If non-solvents are used to enhance agglomeration, moisture is removed even if other residual volatiles may remain. Alcohols, for example, which are compatible with potassium monopersulfate and can be formed into a gel or virtual solid by adding rheology modifiers like Carbopol®, may remain. Thus, although there may be volatile components in the final composition, the core is substantially free of moisture. Any reference to “drying” during processing the reactor refers to the removal of water, and does not necessarily imply that all volatiles are removed.

A third configuration includes a solution or gel. A slurry is prepared by suspending the core components in a solution or gel. The agent(s) used to suspend the components must have properties such that either one or both of the oxidizer reactant and the oxidizable reactant are immiscible in the solution or gel. The agents used as solution or gel can be either removed or can remain as part of the final core product.

The descriptions of various components and examples of said components are not meant to limit the invention. Other unspecified compounds that perform the same function are considered within the scope of the invention.

### 3) Producing the Core

The core is first produced by using any or a combination of suitable conventional equipment and techniques. Regardless of the equipment or technique, an effective amount of reactants are distributed within the reactor core. The term “effective distribution” is defined by the core's ability to generate the oxidizer product(s) when exposed to water. The components comprising the core can be fed into a mixer/densifier using high, moderate or low shear such as those sold under the trade names “LÖdige CB30” or “LÖdige CB30 Recycler,” a granulator such as those sold under the trade names “Shugi Granulator” and “Drais K-TTP 80”. In some cases, a binder can be combined to enhance core formation. The core components can also be fed into the mixer or agglomerator at separate stages as to form layers thereby separating the oxidizer reactant from the oxidizable reactant. This is relevant when moisture addition is involved in the processing. However, when solvents or binders are used in which at least one of the oxidizer reactant and the oxidizable reactant are immiscible, the core components can be combined in one single stage or in multiple stages.

Furthermore, a spray-drying tower can be used to form a granular core by passing a slurry of components through the spray drier. The reactants and other components that make up the core are fed as a slurry to a fluidized bed or a moving bed drier, such as those sold under the trade name “Escher Wyss.” When using a fluidized bed or a moving bed drier, care must be taken to consider the solubility and reactivity of the components in the core. For example, a halide donor combined directly to the PMPS in a moist environment will give off chlorine gas. To prevent this chlorine emission, the PMPS may first be coated to prevent direct contact between the halide and moisture. Alternatively, an intermediate solvent may be used to shield the PMPS from the moisture. The intermediate solvent is selected such that either the coated PMPS or the halide salt is insoluble or have poor solubility (i.e., alcohols). A binder that is un-reactive with the oxidizer reactant can be combined into the core either before or during the spray drying or spray graining process to enhance agglomeration without compromising oxidizer activity.

In another aspect of the invention, the core components are combined in an alcohol solution that is thickened with a rheology modifier, and then dried in a spray drier, fluidized drier, or the like. This alcoholic gel improves the long-term storability of reactants such as PMPS by further preventing the reactants from coming into contact with water. More details about the alcoholic gel is provided in a copending U.S. patent application Ser. No. 10/913,976 filed on Aug. 6, 2004, which is entitled “Storing a Composition in an Alcoholic Gel.” The combining of the reactant components may be done in-situ during the fluidizing process. Alternatively, the components may be combined externally in a granulator, densifier, agglomerator, or the like prior to the fluidizing process.

Spray graining layers of core components is another way of preventing direct contact between the oxidizer reactant and precursors such as halides that may induce the production of halogen gas. This method is useful when membrane-based coatings are applied as described herein. The membrane-based coating sufficiently suppresses diffusion of the dissolved components through the pores due to osmotic pressure. Molecular diffusion is sufficiently slow to allow for the reactants to dissolve and react prior to diffusion of the produced agent(s).

The oxidizer reactant of the core can be coated with an aqueous solution or slurry of the components that make up the remainder of the core while suspended in a fluidized drier system. The resulting core composition can be either dried and removed from this stage of the process, agglomerated while in the fluidized bed drier, or removed and further mixed using equipment such as the mixer/densifier discussed above.

To further enhance the processing options and maintain the activity of the oxidizer reactant, the oxidizer reactant may be coated independently of other core components to enhance its processing survivability. The coating material may include inorganic and organic materials such as silicates, alkali metal salts, cellulose, polysaccharides, polymaleic acid, polyacrylic acid, polyacrylamindes, polyvinylalcohols, polyethylene glycols, and their surrogates. The coating must have sufficient solubility when exposed to the environmental conditions inside the reactor. For example, alkali metals salts such as magnesium carbonate function as anti-caking agents for PMPS and enhance the oxidizer's processing survivability. However, when exposed to an acidic environment, the alkali rapidly dissolves, exposing the PMPS.

Chitosan is another example of a coating that improves the product's process survivability and hygroscopicity. Under normal storage conditions, when exposed to acidic conditions and in particular organic acids, the polymer becomes very hydrophilic and rapidly dissolves exposing the PMPS. This condition can be exploited by including organic acid donors such as succinic acid into the core composition when using chitosan-coated PMPS. Chitin may also be used instead of chitosan.

Multiple oxidizers can be generated by altering the ratio of core components. Combining reactants to produce N-chlorosuccinimide, hypochlorous acid, and chlorine dioxide can provide synergistic effects from one product by using multiple mechanisms of oxidation.

Examples of oxidizable reactants consumed or altered in the reaction with the oxidizer include but are not limited to: halogen donors such as NaCl and NaBr, organic carboxylic acids having from 1-10 carbons and at least 1-carboxylic acid (COO—) group such as citric acid or acetic acid donors, ketones, and aldehydes. Examples of oxidizable substances not consumed or altered in the reaction are: transition metal donors such as iron or copper salts or bound by chelants.

### 4) Coating Material for the Reactor Wall

After the reactants are selected, the coating material for encapsulating the reactants is selected. With proper selection of coating material based on its solubility in water, water permeates through the coating and activates the reactants inside by dissolving them. At the same time, the reactants are contained within the walls of the coating and not allowed to diffuse out through the coating until the reaction has progressed beyond a critical point. By restricting the diffusion of reactants, their respective molar concentrations inside the coating remain high, increasing the yield of the agents.

The pores and other openings in the reactor wall allow the oxidizer product to migrate out of the reactor. Initially, osmotic pressure on the reactor wall increases, thereby squeezing in the main solvent into the reactor. A controlled permeation of the oxidizer product from the inside of the reactor occurs to prevent the reactor wall from rupturing. This permeation is enhanced by the gas(es) often produced during the chemical reaction in the reactor. The rate of permeation both into and out of the reactor is controlled by the size and the number of the pores in the reactor wall.

Two properties are desirable in the coating material: 1) it allows for adequate permeation of water to dissolve the reactants in the core, thereby triggering a chemical reaction inside the reactor, and 2) it acts as a barrier for preventing the reactants from diffusing out to the water body before the reaction has progressed enough to have generated a predetermined level of the desired oxidizer product. Both of these properties depend on the solubility of the coating material, which in turn may depend on the surrounding conditions (e.g., pH, solvent type). Thus, the elements surrounding conditions should be taken into consideration when choosing the coating material.

In a first embodiment, the coating material is silicates, silicones, polysiloxane, and polysaccharides including chitosan and chitin. The silicate-based coating material may be something that contains silicate, such as metasilicate, borosilicate, and alkyl silicate.

How suitable a particular coating material is for a given application depends on the surrounding conditions. For example, silicate coatings are well established for providing a barrier film of protection to percarbonates and other bleaching agents used in laundry detergents but do not always make a reactor. In laundry detergents, the inclusion of bleach precursors such as tetraacetyl-ethylenediamine or nonanoyl-oxybenzene sulfonate to enhance the bleaching performance in low temperatures is common. The hydrolysis of the precursors requires alkaline pH conditions. In such applications, due to the hydrolysis requirements and peroxygen chemistry, the internal and external solution used to dissolve the reactants is high in pH. The silicate coating is soluble under alkaline conditions, and the integrity of the reactor wall is compromised. The coating dissociates rapidly, without acting as a reactor. In this case, the benefit of the high reaction yield is not achieved.

Silicates provide for a simple and inexpensive reactor coating when used in lower pH applications or formulations that result in internal acidic pH conditions that sustain the integrity of the reactor wall. This usefulness of silicates remains uncompromised even if the external conditions are alkaline in pH, such as in the case of laundry water. Silica solubility is poor at low pH. At lower pH, silica remains colloidal and forms a colloidal gel. When monopersulfate (MPS) and a source of chloride such as NaCl are encased within a coating of silicate such as sodium silicate, then added to water, the water permeates through fissures and cracks in the coating and dissolves the reactants. The resulting low pH (<5) from the dissolving MPS suppresses the dissolution rate of the surrounding silica, and the silica remains as a colloidal gel.

Inside the space enclosed by the silica gel coating, the concentration of reactants remains high and the resulting reactions produce high yields of chlorine gas. Upon diffusion of the reactants and the chlorine into the surrounding water, hypochlorous acid and hypochlorite ions form as a function of the water's pH. The resulting conversion to the oxidizer product is therefore much higher when the pH inside the reactor is low and the reactor wall remains undissolved. With the inclusion of N-succinimide, it is now possible to produce N-chlorosuccinimide with the slow-diffusing chlorine gas. pH buffers can be added to further ensure efficacy based on application requirements. In alkaline pH conditions such as laundry bleaching, the elevated pH will not allow for generation of the N-chlorosuccinimide. By sustaining the integrity of the reactor, the internal conditions of the reactor are such that the reactions are successfully carried out. The oxidizer product is efficiently generated and released.

In a second embodiment, the reactor wall is made of a generally hydrophobic substance that includes hydrophilic constituents. A mixture of hydrophobic and hydrophilic substance is applied to the core and dried. Upon addition of water, the hydrophilic component dissolves and the hydrophobic polymer remains intact, forming a porous shell around the core. Water permeates through the pores to reach the core and trigger a chemical reaction. Then, eventually, after the product concentration reaches the critical level, the hydrophobic substance dissolves. More details about this coating process are provided below.

Applications where alkaline pH aquatic conditions are achieved or increased control of diffusion rates is desired can utilize hydrophobic coatings combined with hydrophilic agents. This hydrophobic coating material may be useful with an alkaline-pH aquatic environment where the silicate coating is ineffective as a reactor. As mentioned above, hydrophobic coatings may possess hydrophilic portions, such as some hydrophilic functional groups inherent in the polymer structure. However, the hydrophobic coatings have a hydrophobic backbone that limits their solubility substantially, thereby allowing them to effectively function as a reactor by maintaining the integrity of the reactor walls until the reaction inside has progressed beyond a critical point. This critical point may be defined by a condition such as the pH of the solution inside the reactor or the concentration of the oxidizer product.

Examples of hydrophobic polymers include but are not limited to Polyoxyethylene alcohols such as R(OCH2CH2)nOH, CH3(CH2)m(OCH2CH2)nOH, and polyoxyethylene fatty acid esters having the general formula RCOO(CH2CH2O)nH, RCOO(CH2CH2O)nOCR, oxirane polymers, polyethylene terephthalates, polyacrylamides, polyurethane, latex, epoxy, and vinyl, cellulose acetate. Suitable hydrophilic components include but are not limited to: polycarboxylic acids such as polymaleic acid, polyacrylic acid, and nonionic and anionic surfactants such as ethoxylated or sulfonated alkyl and aryl compounds.

The non-solvent is generally hydrophilic and is removed after the application of the coating to leave voids and channels. The amphipathic agent is used to combine the polymer coating with the hydrophilic non-solvent. The resulting coat is usually micro-porous but the process may be altered to form macro-porous voids and channels. The ratio of solvent to non-solvent as well as non-solvent selection can be adjusted to provide varying degrees of pore size, distribution, and symmetry.

Polysiloxane emulsified in water using water-soluble surfactants provides for an effective coating in pH-sensitive applications. The emulsion is applied to the composition's core (i.e., to the reactants) and then dried, as is performed in the application of the silicates. However, when exposed to water, the hydrophilic component dissociates, forming pores in the hydrophobic polysiloxane coating. The water then permeates into the reactor dissolving the core and activating the reactants. The reactions produce the desired oxidizer products in high yield, and these oxidizer products act on the bulk body of water when the reactor wall dissolves. Due to the high chemical stability of the polysiloxane, the integrity of the reactor coating remains uncompromised in alkaline pH conditions.

In a third embodiment, the reactor wall 10 is a hydrophobic and porous membrane. A second coating can be applied to improve the shelf life in high-humidity storage conditions. To further improve on the diffusion rates by providing for a controlled porosity and pore symmetry, the hydrophobic components such as cellulose acetate can be dissolved in a solvent and combined with a non-solvent that is amphipathic or has a hydrophilic functionality. After forming the coating, both the solvent and non-solvent are removed (e.g., evaporated) leaving a coat with specific porosity. The porosity can be altered by controlling the ratio and types of non-solvent and solvent to the hydrophobic component. For example, addition of ethanol into a mixture of acetone/water-magnesium perchlorate (solvent/non-solvent mixture) produces asymmetrical pores. “Solvents” have the ability to dissolve the hydrophobic polymer while being soluble in the non-solvent.

The hydrophobic component can be any number of thermoplastics and fiber forming polymers or polymer precursors, including but not limited to polyvinyl chloride, polyacrylonitrile, polycarbonate, polysulfone, cellulose acetates, polyethylene terephthalates, and a wide variety of aliphatic and aromatic polyamides, and polysiloxane. Using this coating technology, a membrane with controlled porosity is produced. Representative synthetic polymers include polyphosphazines, poly(vinyl alcohols), polyamides, polycarbonates, polyalkylenes, polyacrylamides, polyalkylene glycols, polyalkylene oxides, polyalkylene terephthalates, polyvinyl ethers, polyvinyl esters, polyvinyl halides, polyvinylpyrrolidone, polyglycolides, polysiloxanes, polyurethanes and copolymers thereof. Other suitable polymers include, but are not limited to, methyl cellulose, ethyl cellulose, hydroxypropyl cellulose, hydroxypropyl methyl cellulose, hydroxybutyl methyl cellulose, cellulose acetate, cellulose propionate, cellulose acetate butyrate, cellulose acetate phthalate, carboxymethyl cellulose, cellulose triacetate, cellulose sulfate sodium salt, poly(methyl methacrylate), poly(ethyl methacrylate), poly(butyl methacrylate), poly(isobutyl methacrylate), poly(hexyl methacrylate), poly(isodecyl methacrylate), poly(lauryl methacrylate), poly(phenyl methacrylate), poly(methyl acrylate), poly(isopropyl acrylate), poly(isobutyl acrylate), poly(octadecyl acrylate) polyethylene, polypropylene, poly(ethylene glycol), poly(ethylene oxide), poly(ethylene terephthalate), polyvinyl acetate), polyvinyl chloride, polystyrene, polyvinyl pyrrolidone, and polyvinyiphenol. Representative bioerodible polymers include polylactides, polyglycolides and copolymers thereof, poly(ethylene terephthalate), poly(butic acid), poly(valeric acid), poly(lactide-co-caprolactone), poly[lactide-co-glycolide], polyanhydrides, polyorthoesters, blends and copolymers thereof.

More specifically, cellulose acetate phthalate such as CA-398-10NF sold by Eastman Chemical Company may be used as the coating material. Under low pH conditions like those previously described for production of N-chlorosuccinimide, the coating remains stable. However, when the core components are depleted, the higher pH (>6.0) dissolves the coating. The porosity can be controlled by dissolving the cellulose in a solvent, then adding an effective amount of non-solvent. After application of the coating, the solvent and non-solvent are removed via evaporation, leaving behind a membrane with a distinct porosity. The porosity can be further altered in symmetry, number of pores, and size of pores by altering the coating components and processing. For example, a decrease in solvent to polymer (S/P) ratio, an increase in nonsolvent/solvent (N/S) ratio, an increase in nonsolvent/polymer (N/P) ratio in the casting solution composition, and a decrease in the temperature of the casting solution tend to increase the average size of the pores on the surface of resulting membranes. Further, an increase in S/P ratio in the casting solution composition, and an increase in the temperature of the casting solution, tend to increase the effective number of such pores on the membrane surface.

Some applications may benefit from a membrane that provides a long term treatment with antimicrobial agents. After the core is extruded, the membrane coating is formed by either directly applying a film-forming membrane and evaporating off any solvents (including water) and non-solvent in the membrane. Alternatively, after the core is extruded, the phase inversion process may be used to produce long fibrous solvent-activated reactors that can be woven or combined with woven materials. The membrane formation process will now be described.

To further improve the stability of the formed polymer membrane, an alloy component can be incorporated into the membrane to form an alloyed reactor wall membrane. For example, addition of poly(phenylene oxide dimethyl phosphonate) to cellulose acetate on a 1:1 w/w mixture can increase membrane tolerance from a pH of <8 to a pH of 10-10.7 for extended usage. An alloying compound is typically an organic component that is combined with the primary hydrophobic component that enhances the polymer membrane's chemical and/or thermal stability. The alloying compound can also be a cross-linking agent such as triflic acid with phosphorous pentoxide, trifluoromethansulfonate, etc., or a plasticizer.

In some embodiments, a cross-linking agent that enhances the structural integrity and rigidity with a polymer precursor such as styrene is included in the reactor wall. Styrene, a cross-linking agent such as divinylbenzene, a solvent, and non-solvent are mixed and applied to form an effective film, followed by the step of initiating polymerization by applying a persulfate or activating peroxide solution before removing the solvent and non-solvent by evaporative drying. The persulfate may be applied during the removal of the solvent and non-solvent, in situ. After the drying, a plastic coating layer having a micro- or macro-porous structure with substantially improved rigidity and strength is obtained.

A plasticizer may also be used to increase the pliability as well as alter the hygroscopicity of the membrane coating.

Alloying compounds such as plasticizers and cross-linking agents may be incorporated into the reactor wall to further improve its structural integrity and/or stability across different temperature and pH ranges. As stated above, the alloying component can also be a cross-linking agent such as triflic acid with phosphorous pentoxide, trifluoromethansulfonate, and the like.

### 5) Multiple Reactor Walls

A single reactor may contain more than one reactor wall. For example, a silicate-coated-core can be further treated with a second coating of chitosan to improve its fluidity and hygroscopic properties. Upon exposure to a bulk quantity of water, the chitosan is dissolved and the silica-coated reactor is exposed. Also, where enhanced storage stability is required, such as high humidity exposure, a secondary coating that enhances the hygroscopicity of the reactor-encased composition may be applied. The invention is not limited to a specific number of reactor wall. Examples of dual-reactor embodiments are provided below. Reactors may also be prepared with more than two layers of reactor walls, depending on the application.

### 6) Forming the Reactor Wall

The coating material may be applied to the core in the form of an aerosol, a liquid, an emulsion, a gel, or a foam to form the reactor wall. The preferred form of coating depends on the composition of the coating being applied, the application equipment, and conditions. The coating generally comprises from 0.2 to 5% of the total weight of the solvent-activated reactor. However, the actual amount of membrane coating can vary based on the size of the reactor, porosity and the like.

In one aspect, the invention is a method of producing the reactor described above, and also a method of using the reactor to treat an aquatic system. The invention is a method of generating high yields of oxidizers, biocides and/or virucidal agents in-situ by using the reactor that is described above. The reaction in the reactor is triggered when the reactor is exposed to the body of water that is to be treated by the products of the reaction.

The core that is formed as described above is coated with an effective amount of coating material. The “effective amount” of coating takes into consideration the solubility characteristics of the coating under the conditions in the application so as to ensure that the structural integrity of the reactor remains sufficiently intact until such time as the reactants have been depleted. The coating material may be applied by using any effective means of distributing the coating material over the surface of the core, such as spray coating in a fluidized bed, or applying a foam or liquid containing the coating material and mixing. Then, the coated composition is dried by using an effective means of drying, such as a fluidized drier or a tray drier, rotary drier and the like.

Once the core has been produced, the coating is effectively applied in the form of liquid, foam, gel, emulsion and the like. The coating can be applied by aerosol, spray, immersion and the like. The coating may be applied with a mechanical mixing device such as a blender/mixer, then dried using any number of batch or continuous drying techniques such as tray driers, rotary driers, fluidized bed driers, and the like. The preferred technique is to accomplish coating and drying in a continuous fluidized bed drier. The fluidized bed drier can incorporate multiple stages of drying to apply multiple applications of coating, perform different steps in the coating process (i.e., coating, polymerization, evaporation) and the like under continuous or batch processing. Generally, the product temperature during the coating process should not exceed 100° C. and preferably 70° C. During membrane coating, the application of the coating should occur at <50° C. and preferably <30° C. depending on the solvent and non-solvent that are used.

The order of application, evaporation, drying, etc. of the coating material varies based on the types of polymers, solvents, non-solvents and techniques used to produce the porous membrane. For example, a cellulose acetate membrane is effectively applied by first dissolving the cellulose polymer in a solvent, then adding a non-solvent such as water and magnesium perchlorate to produce the gel. The gel is coated on the core by spraying or otherwise applying a thin film of gel onto the surface of the core, then evaporating the solvent and the volatile components of the non-solvent.

A polyamide membrane can be produced by using the method that is commonly referred to as the “phase inversion process.” The phase inversion process includes dissolving a polyamide in a solvent such as dimethyl sulfoxide to form a gel, applying the gel to form a thin film, then applying the non-solvent to coagulate the polymer. Then, the solvent and non-solvent are evaporated.

### Example 1

This example illustrates the generation of N-chlorosuccinimide using the invention, and explains its utility.

Conventionally, laundry bleaching utilizes liquid or dry chlorine bleaching agents for white fabrics and peroxygen compounds such as percarbonate for colored fabrics. To further improve the removal of colored stains, precursors are incorporated into the laundry detergents to produce peracids (e.g., peracetic acid) in-situ. The effectiveness of these treatments is based on factors such as contact time, temperature, concentration, types of stains, demand for oxidants in the water, and the like.

Generally, the effectiveness of treating color stains and in many cases stains on white fabrics is limited. Thus, additional treatment steps are commonly employed to successfully remove the stains, as illustrated in the published application WO9923294. This published application discloses a multi-step process to improve the effectiveness of stain removal, wherein one of the steps employs dioxirane.

By utilizing the reactor, a combination of agents, each with its own selective order of reactions, may be employed in one step. The synergistic effect of combined treatments substantially improves performance in stain removal without the problems associated with high dosages of single indiscriminate treatments, such as bleaching of colors and fabric decomposition).

Set-in protein based stains are difficult to treat due to their insoluble composition. Peroxygen compounds and peracids are effective at decomposing the soluble components that increase the COD of the wash water. However, the efficiency of the reactions (gms oxidant/gm COD) needs to be considered for bleaching efficacy. By selecting reactant components based on their reaction selectivity, the efficacy of the bleaching process is improved.

The difficulty in selecting and applying the components is a result of their storage stability, ability to formulate, and condition (chemistry) requirements for in-situ generation. For example, acid catalyzed reactions are not well suited for the alkaline conditions experienced in laundry wash water.

By employing the reactor of the invention, the issues of stability, formulation, and in-situ generation are addressed. Lower levels of highly selective agents can be produced in-situ that carry out specific tasks. For example, N-chlorosuccinimide is very effective at decomposing tryptophan peptide bonds that bind the high molecular weight (water insoluble) proteins. N-chlorosuccinimide may be generated using a core that includes a halogen donor such as NaCl and an oxidizer such as potassium monopersulfate, persulfates, or peroxyphthalate. The halogen donor and the oxidizer will produce hypohalite (OCl⁻). With the pH suppressed to <6.0, chlorine gas results as an equilibrium product of the halogen species. Including a N-hydrogen donor such as N-succinimide, isocyanuric acid, 5,5-alkylhydantoin, or N-sulfamate, a stable antimicrobial agent is produced such as N-chlorosuccinimide as in the case of N-succinimide reacting with chlorine gas.

When decomposition occurs, smaller water-soluble byproducts are produced. The carbon based compounds are readily oxidized by oxygen-based oxidizers such as dioxirane, peracids or chlorine dioxide. Hydroxyl radicals further enhance decomposition of these compounds and significantly improve the rate of decomposition by hydrogen cleavage, radical formation, and autocatalytic decomposition.

The result of utilizing selective chemistry minimizes the amount of reactants that is required while maximizing bleaching efficacy. Resistant stains that otherwise survive non-chlorine bleach detergent blend are effectively cleaned without the damage resulting from higher concentrations, direct contact with ready to use bleaching agents, and use of indiscriminate bleaching agents. It also provides for an easy single-step application.

### Example 2

The reactor of the invention may be used to generate multiple oxidizer products by customizing the reactions and selecting the reactants for a specific application. For example, in bleaching processes, combining dioxirane and peracids with residual PMPS provides for multiple mechanisms of oxidation and bleaching. In antimicrobial applications, combining chlorine dioxide with residual hypohalite and/or haloimide provides for a broad-spectrum inactivation of microorganisms and enhanced efficacy over single species applications. This example illustrates the generation of peracetic acid and dioxirane using an acidic reactor environment.

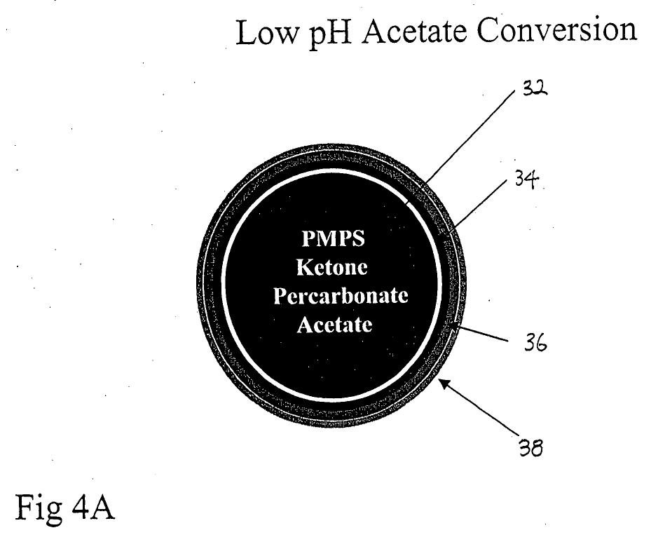

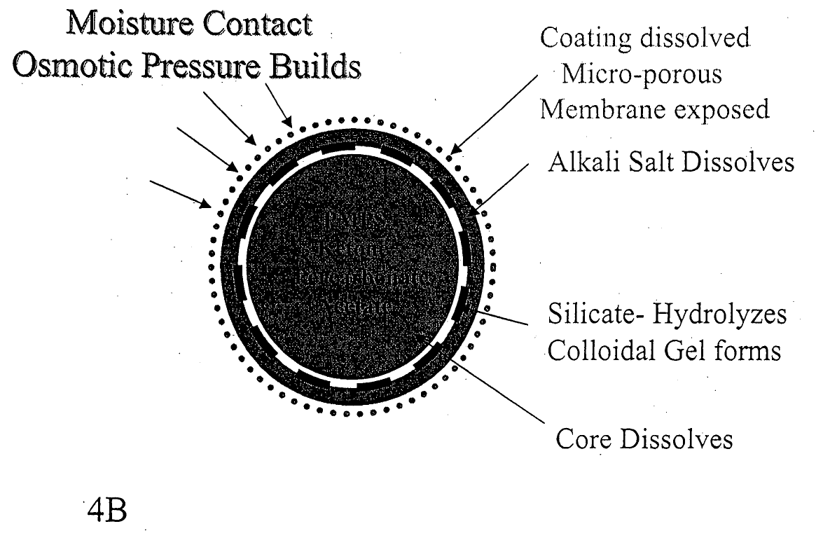

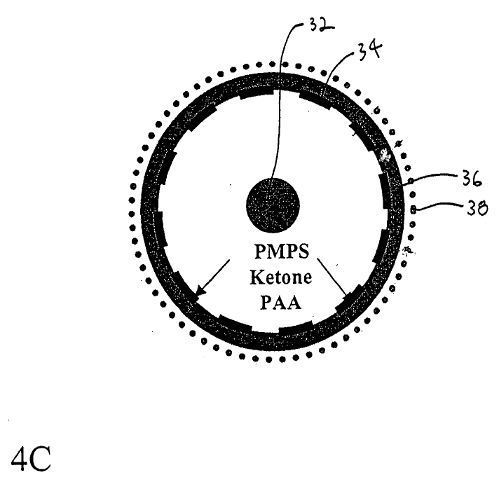

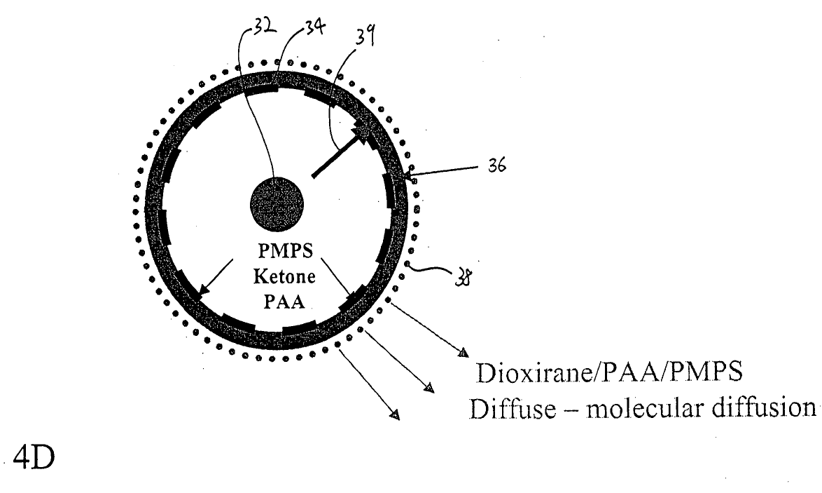

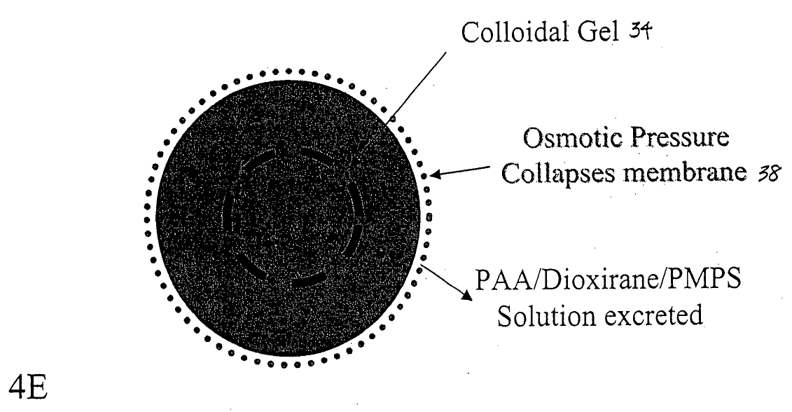

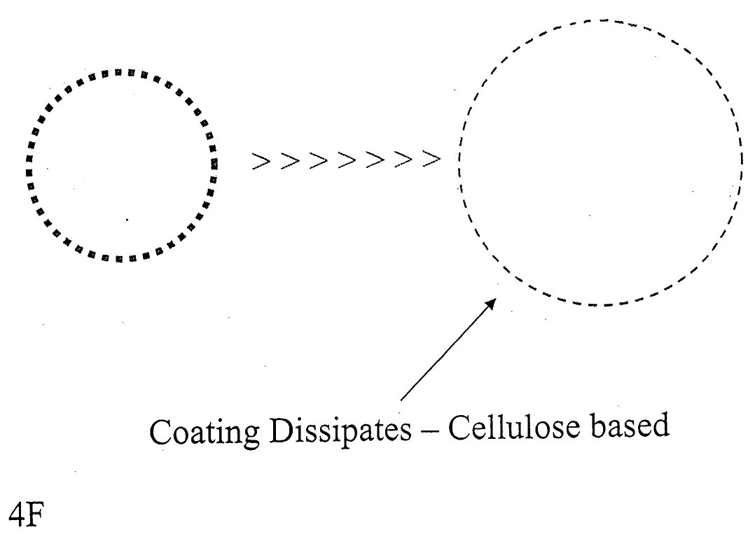

FIGS. 4A, 4B, 4C, 4D, 4E, and 4F show a reactor 30 for generation of multiple oxidizer products under acid catalyzed conditions. The oxidizer products include peracetic acid, which is most efficiently produced under low pH, and dioxirane, which is most efficiently produced under neutral-pH conditions. As shown in FIG. 4A, the reactor 30 includes a core 32, a silicate coating 34, an alkali salt coating 36, and a cellulose triacetate membrane 38. The core 32 includes PMPS (the oxidizer reactant), ketone, percarbonate, and acetate.

The reactor 30 is multi-layered. The silicate coating 34 forms an inner reactor, and the cellulose triacetate membrane forms the outer reactor that contains the inner reactor. The inner reactor generates the peracetic acid and the outer reactor generates the dioxirane. By forming the core 32 with an acidic oxidizer reactant such as PMPS, a hydrogen peroxide donor (e.g., percarbonate), an acetic acid donor (e.g., sodium acetate), and a carbonyl donor (e.g., dihydroxyacetone, ketone) in one reactor (e.g., silicate coating), surrounding the reactor with an effective dose of alkali salt (e.g., sodium carbonate), and coating the alkali salt coating 36 with yet a second reactor coating such as a cellulose triacetate membrane 38, the reactor 30 maximizes the generation of peracetic acid and dioxirane.

FIG. 4B shows that upon contacting water, pores form in the cellulose triacetate membrane 38. Moisture permeates the cellulose membrane 38 through the pores and dissolves some of the alkali salt coating 36 and hydrolyzes the silicate coating 34. The silicate coating 34 (colloidal gel), which forms the wall of the inner reactor, allows for moisture to permeate and reach the core 32. Once the moisture permeates to the core, the reactants in the core are activated, creating an acidic condition (FIG. 4C). As shown in FIG. 4C, the activated reactants dissociate, shrinking the core 32 and reducing the pressure inside the reactor 30. Since the cellulose triacetate membrane 38 has pores, the silica coating 34 supports the cellulose membrane 38. Peracetic acid, residual PMPS, and carbonyl donor (e.g., ketone) are generated by the reaction in the inner reactor (FIG. 4C). Because the cellulose membrane 38 is micro-porous, the rate at which the peracetic acid, the residual PMPS, and the carbonyl donor diffuse out of the reactor 30 is limited.

As the peracetic acid, the residual PMPS, and the carbonyl donor from the inner reactor pass into the alkali salt coating 36 as shown by an arrow 39, the rise in pH induces the generation of dioxirane by activating a PMPS-carbonyl donor reaction (FIG. 4D). The peracetic acid, dioxirane, and residual PMPS diffuse through the porous cellulose triacetate membrane 38. The raised pH collapses the silicate coating 34, which then decomposes. Without the silicate coating 34 to provide extra support against the osmotic pressure difference between the inside and the outside of the reactor 30, the cellulose triacetate membrane 38 also collapses (FIG. 4E). After collapsing, the cellulose-based cellulose triacetate membrane 38 dissipates (FIG. 4F) and the reactor 30 is gone.

As illustrated above in FIG. 4A, a reactor may contain multiple sub-reactors (e.g., an inner reactor and an outer reactor) with each sub-reactor generating a specific oxidizer product. When generating multiple oxidizer products, the oxidizer product combinations are selected such that they can be generated under the same conditions.

### Example 3

This example illustrates the generation of peracetic acid and dioxirane in a neutral to alkaline reactor environment.

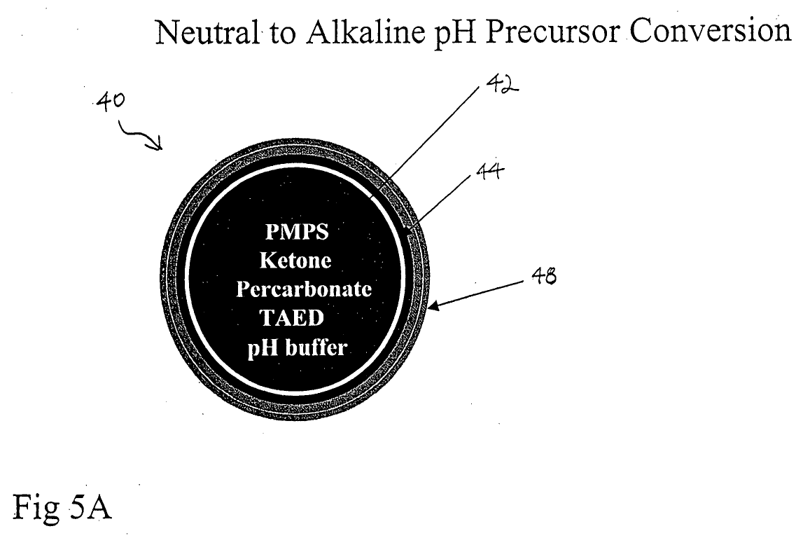

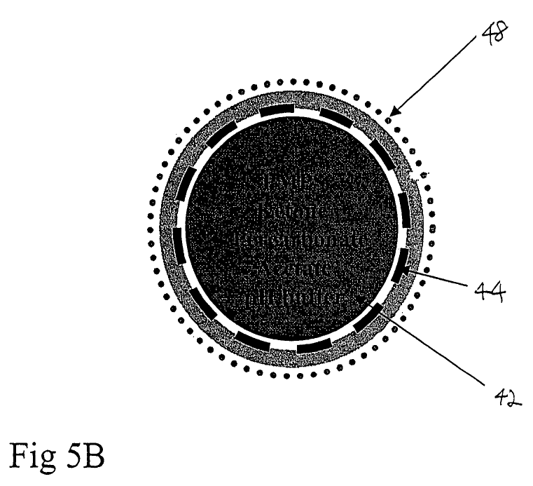

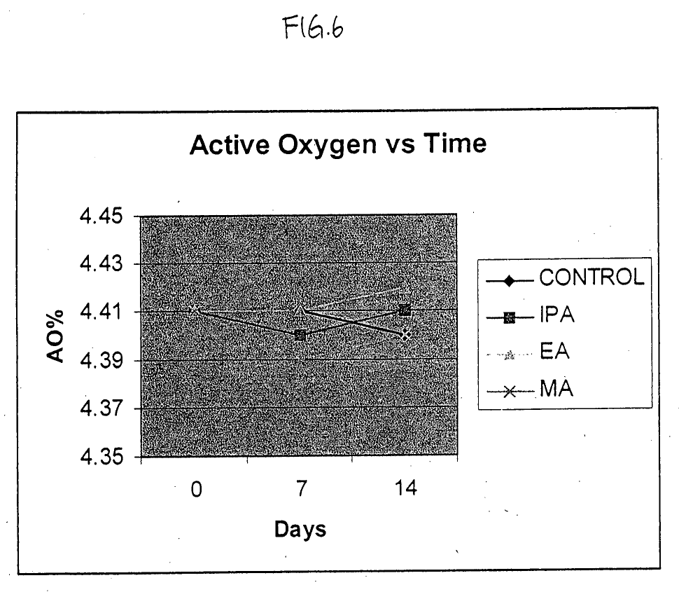

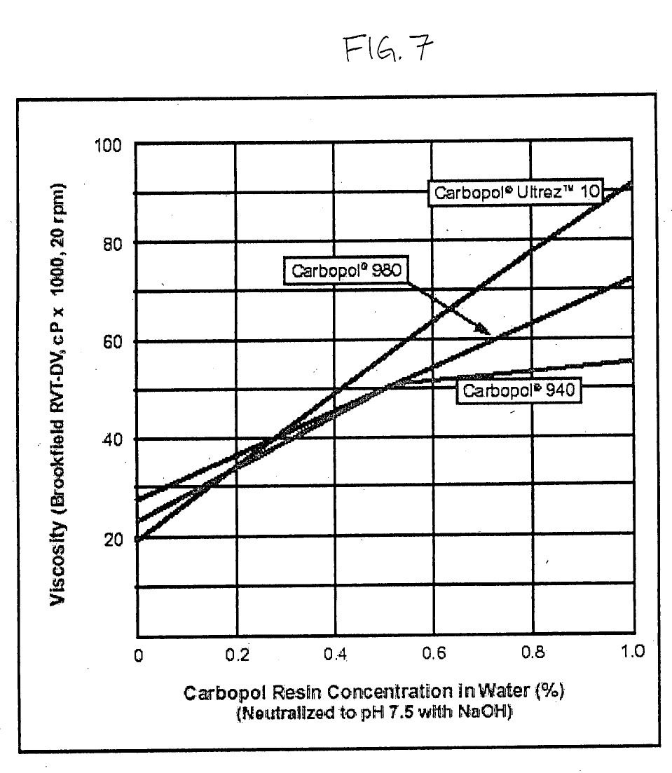

FIGS. 5A and 5B illustrate a reactor 40 for generation of multiple oxidizer products under neutral to alkaline pH using stable polyester membrane reactor coating 48. The oxidizer products include peracetic acid and dioxirane. As described above, PMPS can be combined with organics containing carbonyl groups (e.g., ketone, aldehyde, carboxylic acid) to produce dioxirane. Dioxirane formation is most efficient around neutral pH. As FIG. 5A shows, the reactor 40 includes a core 42, a silicate coating 44, and the polyester membrane 48. In the example shown in FIG. 5A, the core contains PMPS, a carbonyl donor (ketone in this case), a percarbonate, an acetate, and a pH buffer.

Moisture permeates the polyester membrane 48 through the pores in the membrane and hydrolyzes a silicate coating 44 to form a colloidal gel. The silicate coating 44, which forms the wall of the inner reactor, allows for moisture to permeate and reach the core 42. Once the moisture permeates to the core, the reactants in the core are dissolved to form an alkaline condition (FIG. 5B). Tetraacetyl-ethylenediamine (TAED) and PMPS react to produce peracid in high yield in an alkaline condition. The alkaline condition activates a PMPS-carbonyl donor reaction and generates dioxirane. As the reactants dissociate through a chemical reaction, the core 42 decreases in size. Eventually, the osmotic pressure difference between the inside and the outside of the reactor 40 collapses the reactor 40 (not shown).

### Example 4

Where the oxidizer product is dioxirane, the oxidizer reactant is one of potassium persulfate, sodium persulfate, ammonium persulfate, potassium monopersulfate, permanganate, and a Caro's acid precursor. The Caro's acid precursor is a combination of a peroxide donor (e.g., urea peroxide, calcium peroxide, magnesium peroxide, sodium peroxide, potassium peroxide, perborate, perphosphate, persilicate, and percarbonate) and a sulfuric acid donor (e.g., sodium bisulfate and pyrosulfate and a sulfuric acid donor). In addition to the oxidizer reactant, the core may also include an organic compound containing carbonyl groups (C═O) to produce dioxirane. Preferably, the organic compound has 3-20 carbons. The core composition may be 10-80 wt. % oxidizer reactant and 0.5-40 wt. % carbonyl donor such as aldehydes, ketones, and carboxylic acids. If a binder or a pH buffer is used, each of these components does not make up more than 30 wt. % of the core. If a filler is used, it does not exceed 50 wt. % of the core. Dioxirane formation is typically most efficient around neutral pH.

A composition for bleaching laundry and textiles in alkaline wash-water can be prepared using a porous reactor for in-situ generation of dioxirane in combination with one or more oxidizing agents. The oxidizing agent may be a hypohalite donor, chlorine dioxide donor, halo-amine donor, percarboxylic acid donor, hydroxyl radical donor, persulfate(s), and hydrogen peroxide donor. The reactor is comprised of a core of components that, when dissolved by water, react to generate dioxirane. The core is contained in a porous coating that controls the rate of water diffusion to the core. The coating also controls the rate at which the core components and dioxirane reach the bulk water. Whereby the dioxirane results from in-situ generation initiated by the wash-water permeation through the porous coating, dissolution of the core components, reaction of the core components, and diffusion of the produced dioxirane into the wash-water. Whereby the coating has substantially lower solubility in the water than the core components and the resulting produced agent, and possesses sufficient chemical stability as to retain its integrity as a reactor by restricting the diffusion of wash-water to the core until the core components have been depleted.

### Example 5

Where the oxidizer product is a peroxycarboxylic acid, it can be produced with a core that includes an oxidizer reactant such as urea peroxide, calcium peroxide, magnesium peroxide, sodium percarbonate, sodium perborate, persulfate(s), monopersulfate, persilicate, perphosphate, sodium peroxide, lithium peroxide, potassium peroxide, or permanganate. The core may also include a carboxylic acid donor such as acetic acid in the form of sodium acetate. Another example is inclusion of tetraacetyl-ethylenediamine (TAED) with the peroxide donor for production of peracid in alkaline conditions. The core composition is about 10-80 wt. % oxidizer reactant and about 0.5-40 wt. % carboxylic acid donor. Optionally, a binder, a filler, and a pH buffer may be added to the core but they cannot make up more than 30, 50, and 30 wt. % of the core, respectively. The core is at least 50 wt. % solids. The molar ratios are optimized and addition of pH buffers is employed in the core composition before coating. Upon dilution with water, the core dissolves and produces a ready source of peracetic acid in high yield.

### Example 6

Where the oxidizer product is a hypohalite, the reactant in the core may be potassium persulfate, sodium persulfate, ammonium persulfate, potassium monopersulfate, permanganate, or a Caro's acid precursor. The Caro's acid precursor is a combination of a peroxide donor (urea peroxide, calcium peroxide, magnesium peroxide, sodium peroxide, potassium peroxide, perborate, perphosphate, persilicate, and percarbonate) and a sulfuric acid donor (sodium bisulfate and pyrosulfate). The core is about 10-80 wt. % oxidizer reactant and about 0.5-10 wt. % halogen donor. Optionally, a binder, a filler, and a pH buffer may be added to the core but they cannot make up more than 30, 50, and 30 wt. % of the core.

### Example 7

Where the oxidizer product is an N-haloamine, the reactant may be a potassium persulfate, sodium persulfate, ammonium persulfate, potassium monopersulfate, permanganate, or a Caro's acid precursor. The core may also include a monovalent metal salt, a divalent metal salt, or a trivalent metal salt, as well as an N-hydrogen donor capable of reacting with hypo-halite to generate the oxidizer product and a chlorate donor. The composition of the core is about 10-80 wt. % oxidizer reactant, 0.5-10 wt. % a halogen donor, and 0.5-30 wt. % N-hydrogen-donor. Optionally, a binder, a filler, and a pH buffer may be added to the core but they cannot make up more than 30, 50, and 30 wt. % of the core, respectively. Since N-halo-amine production is more efficient at low pH than at high pH and the wash water is usually alkaline, a dramatic increase in yield may be achieved by providing an acid-catalyzed environment inside the reactor.

### Example 8

Where the oxidizer product is chlorine dioxide, the core composition is about 10-80 wt. % reactant, about 0.5-10 wt. % halogen donor, and about 0.5-20 wt. % chlorite donor. A binder, a pH buffer, and a filler may be used optionally but not in amounts exceeding 30 wt. %, 30 wt. %, and 50 wt. % of the core, respectively. In one embodiment, the reactant in the core may be potassium persulfate, sodium persulfate, ammonium persulfate, potassium monopersulfate, permanganate, or a Caro's acid precursor The halogen donor may be, for example, a mono-valent or di-valent metal salt. The chlorate donor may be sodium chlorate.

In another embodiment, the reactant is urea peroxide, calcium peroxide, magnesium peroxide, sodium percarbonate sodium perborate, persulfate(s), monopersulfate, persilicate, perphosphate, sodium, lithium, or potassium peroxide. A halogen donor and a chlorate donor such as sodium chlorate, potassium chlorate, lithium chlorate, magnesium chlorate, and calcium chlorate may be included in the core.

In either embodiment, the binder, the filler, and the pH buffer may be used optionally, but not in amounts more than 30, 50, and 30 wt. % of the core, respectively. Since chlorine dioxide production is more efficient at low pH than at high pH and the wash water is usually alkaline, a dramatic increase in yield may be achieved by providing an acid-catalyzed environment inside the reactor.

### Example 9

Where the oxidizer product is a hydroxyl radical, the core composition may be about 10-80 wt. % reactant, about 0.001-10 wt. % a transition metal donor, and about 1-30 wt. % pH buffer. In addition, a binder and a filler may be used. However, each of the binder and the filler is preferably not present in an amount exceeding 30 and 50 wt. % of the core, respectively. The reactor in the core may be urea peroxide, calcium peroxide, magnesium peroxide, sodium percarbonate sodium perborate, persulfate(s), monopersulfate, persilicate, perphosphate, sodium, lithium, permanganate, or potassium peroxide. The transition metal is a chelating agent selected from a group consisting of trisodium pyrophosphate, tetrasodium diphosphate, sodium hexametaphosphate, sodium trimetaphosphate, sodium tripolyphosphate, potassium tripolyphosphate, phosphonic acid, di-phosphonic acid compound, tri-phosphonic acid compound, a salt of a phosphonic acid compound, ethylene diamine-tetra-acetic acid, gluconate, or another ligand-forming compound.

Hydroxyl radical may be produced with a reactor that contains a metal catalyst. The metal catalyst may be contained in the core, coated on the core, or included in the reactor wall, for example in the pores on the membrane. The metal catalyst may be Cu (II), Mn (II), Co (II), Fe (II), Fe (III), Ni (II), Ti (IV), Mo (V), Mo (VI), W (VI), Ru (III), or Ru (IV). Upon dilution with water the composition releases peroxide. Under neutral to acidic conditions, the oxidizer reactant is converted to hydroxyl radicals upon reaction with the catalyst. The catalyst remains unaltered.

One benefit of the invention is to control the reactor chemistry as to maximize the concentration of reactants in an environment conducive to forming the oxidizer products. For example, N-chlorosuccinimide generation is best performed under acidic conditions where chlorine gas and/or hypochlorous acid are readily available. In applications such as laundry bleaching, generation of N-chlorosuccinimide is less than optimal because the alkaline pH (generally >9.0) is not well suited for producing N-chlorosuccinimide. By producing N-chlorosuccinimide in a contained space inside the reactor and controlling the diffusion rate of product and reactants out of the reactor, the conditions that are conducive to high conversion rates and yields are sustained. Thus, the yield is maximized prior to the product's being releasing into the alkaline bleaching environment of the wash-water. Similar characteristics are true of the various oxidizers produced by reacting reagents to generate more powerful oxidants in-situ. Conditions such as pH, concentrations of reactants, and minimizing oxidizer demand such as that found in the bulk wash-water must be controlled to maximize conversion of the reactants and the yield of the oxidizer product. Utilizing granules of oxidizers incorporating precursors that require acid catalyzed reactions into alkaline wash water and high demand deplete in-situ efficacy.

The solvent-activated reactors can be used alone, or can be combined with traditional detergent formulations contain: surfactants, builders, chelants, dispersants, alkalinity builders and the like. More information about the solvent-activated reactors are provided in U.S. patent application Ser. No. 10/934,801, which is incorporated herein by reference in its entirety.

While the foregoing has been with reference to a particular embodiment of the invention, it will be appreciated by those skilled in the art that changes in this embodiment may be made without departing from the principles and spirit of the invention.

What is claimed is:

1. A composition for bleaching materials, the composition comprising:
a reactor having pores, wherein the reactor includes:
a core containing an oxidizer reactant that generates dioxirane when contacted by a main solvent, the core being 10-80 wt. % oxidizer reactant, 0.5-40 wt. % carbonyl donor, 0-30 wt. % binder, 0-30 wt. % pH buffering agent, and 0-50 wt. % filler; and
a reactor wall surrounding the core and controlling diffusion of the main solvent to the core through the pores, wherein the reactor wall has a substantially lower solubility in the main solvent than the oxidizer reactant and dioxirane such that the reactor wall remains substantially intact until generation of the dioxirane is substantially complete; and
an oxidizing agent in contact with the main solvent, the oxidizing agent being one of a hypohalite donor, chlorine dioxide donor, halo-amine donor, percarboxylic acid donor, hydroxyl radical donor, persulfate(s), and hydrogen peroxide donor, the oxidizing agent having an order of selectivity that is different from dioxirane.

2. The composition of claim 1, wherein a portion of the oxidizer reactant reacts with the carbonyl donor to generate dioxirane and leaves residual oxidizer reactant as the oxidizing agent.

3. The composition of claim 1, wherein the oxidizing agent diffuses out of the reactor oxidizer product the pores in the reactor wall.

4. The composition of claim 1, wherein substantially all of the oxidizing agent is present outside the reactor.

5. The composition of claim 1, wherein the reactor wall is a porous membrane.

6. The composition of claim 1, wherein the reactor further comprises a layer of protective coating around the core, the layer comprising at least one of a silicate, cellulose, chitin, chitosan, polymaleic acid, polyacrylic acid, polyacrylamides, polyvinylalcohols, polyethylene glycols, and their surrogates.

7. The composition of claim 6, wherein the layer is applied between the core and the reactor wall.

8. The composition of claim 6, wherein the layer is applied around the reactor wall.

9. The composition of claim 1, wherein the reactor wall is a first reactor wall surrounding a first reactor space, the reactor further comprising a second reactor wall formed around the first reactor wall and surrounding a second reactor space, such that the dioxirane is generated in the first reactor space and the oxidizing agent is generated in the second reactor space.

10. A composition for bleaching materials in an alkaline environment, the composition comprising:
a reactor having pores, wherein the reactor includes:
a core containing an oxidizer reactant that generates dioxirane when contacted by a main solvent, the core being 10-80 wt. % oxidizer reactant, 0.5-40 wt. % carbonyl donor, 0-30 wt. % binder, 0-30 wt. % pH buffering agent, and 0-50 wt. % filler; and
a reactor wall surrounding the core and controlling diffusion of the main solvent to the core through the pores, wherein the reactor wall has a substantially lower solubility in the main solvent than the oxidizer reactant and dioxirane such that the reactor wall remains substantially intact until generation of the dioxirane is substantially complete; and
an oxidizing agent mixed with the reactor, the oxidizing agent being one of a hypohalite donor, chlorine dioxide donor, halo-amine donor, percarboxylic acid donor, hydroxyl radical donor, persulfate(s), and hydrogen peroxide donor, the oxidizing agent having an order of selectivity that is different from dioxirane.

11. A composition for bleaching materials, the composition comprising:
a reactor having pores, wherein the reactor includes:
a core that generates percarboxylic acid when contacted by a main solvent, the core being 10-80 wt. % oxidizer reactant, 0.5-40 wt. % carboxylic acid donor, 0-30 wt. % binder, 0-30 wt. % pH buffer, and 0-50 wt. % filler; and
a reactor wall surrounding the core and controlling diffusion of the main solvent to the core through the pores, wherein the reactor wall has a substantially lower solubility in the main solvent than the oxidizer reactant and percarboxylic acid such that the reactor wall remains substantially intact until generation of the percarboxylic acid is substantially complete; and
an oxidizing agent in contact with the main solvent, the oxidizing agent selected from a group consisting of a hypohalite donor, chlorine dioxide donor, halo-amine donor, dioxirane donor, hydroxyl radical donor, persulfate(s), and hydrogen peroxide donor.

12. The composition of claim 11, wherein a portion of the oxidizer reactant reacts with the carboxylic acid donor to generate percarboxylic acid and leaves residual oxidizer reactant as the oxidizing agent.

13. The composition of claim 11, wherein the oxidizing agent diffuses out of the reactor oxidizer product the pores in the reactor wall.

14. The composition of claim 11, wherein substantially all of the oxidizing agent is present outside the reactor.

15. The composition of claim 11, wherein the reactor wall is a porous membrane.

16. The composition of claim 11, wherein the reactor further comprises a layer of protective coating around the core, the layer comprising at least one of a silicate, cellulose, chitin, chitosan, polymaleic acid, polyacrylic acid, polyacrylamindes, polyvinylalcohols, polyethylene glycols, and their surrogates.

17. The composition of claim 16, wherein the layer is applied between the core and the reactor wall.

18. The composition of claim 16, wherein the layer is applied around the reactor wall.

19. The composition of claim 11, wherein the reactor wall is a first reactor wall surrounding a first reactor space, the reactor further comprising a second reactor wall formed around the first reactor wall and surrounding a second reactor space, such that the percarboxylic acid is generated in the first reactor space and the oxidizing agent is generated in the second reactor space.

20. A composition for bleaching materials, the composition comprising:
a reactor having pores, wherein the reactor includes:
a core that generates percarboxylic acid when contacted by a main solvent, the core being 10-80 wt. % oxidizer reactant, 0.5-40 wt. % carboxylic acid donor, 0-30 wt. % binder, 0-30 wt. % pH buffer, and 0-50 wt. % filler; and
a reactor wall surrounding the core and controlling diffusion of the main solvent to the core through the pores, wherein the reactor wall has a substantially lower solubility in the main solvent than the oxidizer reactant and percarboxylic acid such that the reactor wall remains substantially intact until generation of the percarboxylic acid is substantially complete; and
an oxidizing agent in contact with the reactor, the oxidizing agent selected from a group consisting of a hypohalite donor, chlorine dioxide donor, halo-amine donor, dioxirane donor, hydroxyl radical donor, persulfate(s), and hydrogen peroxide donor.

21. A composition for bleaching materials, the composition comprising:
a reactor having pores, wherein the reactor includes:
a core of reactants that react to generate chlorine dioxide when dissolved by a main solvent, the core being 10-80 wt. % of oxidizer reactant, 0.5-10 wt. % a halogen donor, 0.5-20 wt. % a chlorite donor, 0-30 wt. % binder, 0-30 wt. % pH buffering agent, 0-50 wt. filler; and
a reactor wall surrounding the core and controlling diffusion of the main solvent to the core through the pores, wherein the reactor wall has a substantially lower solubility in the main solvent than the oxidizer reactant and chlorine dioxide such that the reactor wall retains integrity until the reactants are substantially depleted; and
an oxidizing agent in contact with the main solvent, the oxidizing agent selected from a group consisting of a hypohalite donor, dioxirane donor, halo-amine donor, percarboxylic acid donor, hydroxyl radical donor, persulfate(s), and a hydrogen peroxide donor.

22. The composition of claim 21, wherein a portion of the oxidizer reactant reacts with the carbonyl donor to generate chlorine dioxide and leaves residual oxidizer reactant as the oxidizing agent.

23. The composition of claim 21, wherein the oxidizing agent diffuses out of the reactor oxidizer product the pores in the reactor wall.

24. The composition of claim 21, wherein substantially all of the oxidizing agent is present outside the reactor.

25. The composition of claim 21, wherein the reactor wall is a porous membrane.

26. The composition of claim 21, wherein the reactor further comprises a layer of protective coating around the core, the layer comprising at least one of a silicate, cellulose, chitin, chitosan, polymaleic acid, polyacrylic acid, polyacrylamindes, polyvinylalcohols, polyethylene glycols, and their surrogates.

27. The composition of claim 26, wherein the layer is applied between the core and the reactor wall.

28. The composition of claim 26, wherein the layer is applied around the reactor wall.

29. The composition of claim 21, wherein the reactor wall is a first reactor wall surrounding a first reactor space, the reactor further comprising a second reactor wall formed around the first reactor wall and surrounding a second reactor space, such that the chlorine dioxide is generated in the first reactor space and the oxidizing agent is generated in the second reactor space.

30. The composition of claim 21, wherein the reactor wall surrounds a reactor space, and wherein the reactor space has a pH level below 7.

31. A composition for bleaching materials, the composition comprising:
a reactor having pores, wherein the reactor includes:
a core of reactants that react to generate chlorine dioxide when contacted by a main solvent, the core being 10-80 wt. % oxidizer reactant, 0.5-10 wt. % a halogen donor, 0.5-20 wt. % a chlorite donor, 0-30 wt. % binder, 0-30 wt. % pH buffering agent, 0-50 wt. filler; and
a reactor wall surrounding the core and controlling diffusion of the main solvent to the core through the pores, wherein the reactor wall has a substantially lower solubility in the main solvent than the oxidizer reactant and chlorine dioxide such that the reactor wall retains integrity until the reactants are substantially depleted; and
an oxidizing agent in contact with the reactor, the oxidizing agent selected from a group consisting of a hypohalite donor, dioxirane donor, halo-amine donor, percarboxylic acid donor, hydroxyl radical donor, persulfate(s), and a hydrogen peroxide donor.

32. A composition for bleaching materials, the composition comprising:
a reactor having pores, wherein the reactor includes:
a core that generates hydroxyl radicals when contacted by a main solvent, the core being 10-80 wt. % oxidizer reactant, 0.001-10 wt. % transition metal donor, 0-30 wt. % binder, 1-30 wt. % pH buffer, 0-50 wt. % filler; and
a reactor wall surrounding the core and controlling diffusion of the main solvent to the core through the pores, wherein the reactor wall has a substantially lower solubility in the main solvent than the reactants and the hydroxyl radicals such that the reactor wall remains substantially intact until generation of the hydroxyl radicals is substantially complete; and
an oxidizing agent in contact with the main solvent, the oxidizing agent selected from a group consisting of a hypohalite donor, dioxirane donor, halo-amine donor, percarboxylic acid donor, chlorine dioxide donor, persulfate(s), and a hydrogen peroxide donor.

33. The composition of claim 32, wherein a portion of the oxidizer reactant reacts is consumed to generate hydroxyl radicals and residual oxidizer reactant forms the oxidizing agent.

34. The composition of claim 32, wherein the oxidizing agent diffuses out of the reactor oxidizer product the pores in the reactor wall.

35. The composition of claim 32, wherein substantially all of the oxidizing agent is present outside the reactor.

36. The composition of claim 32, wherein the reactor wall is a porous membrane.

37. The composition of claim 32, wherein the reactor further comprises a layer of protective coating around the core, the layer comprising at least one of a silicate, cellulose, chitin, chitosan, polymaleic acid, polyacrylic acid, polyacrylamindes, polyvinylalcohols, polyethylene glycols, and their surrogates.

38. The composition of claim 37, wherein the layer is applied between the core and the reactor wall.

39. The composition of claim 37, wherein the layer is applied around the reactor wall.

40. The composition of claim 32, wherein the reactor wall is a first reactor wall surrounding a first reactor space, the reactor further comprising a second reactor wall formed around the first reactor wall and surrounding a second reactor space, such that the hydroxyl radicals are generated in the first reactor space and the oxidizing agent is generated in the second reactor space.

41. The composition of claim 32, wherein the reactor wall surrounds a reactor space, and wherein the reactor space has a pH level below 7.

42. A composition for bleaching materials in an alkaline environment, the composition comprising:
a reactor having pores, wherein the reactor includes:
a core that generates hydroxyl radicals when contacted by a main solvent, the core being 10-80 wt. % oxidizer reactant, 0.001-10 wt. % transition metal donor, 0-30 wt. % binder, 1-30 wt. % pH buffer, 0-50 wt. % filler; and
a reactor wall surrounding the core and controlling diffusion of the main solvent to the core through the pores, wherein the reactor wall has a substantially lower solubility in the main solvent than the oxidizer reactant and hydroxyl radicals such that the reactor wall remains substantially intact until generation of the hydroxyl radicals is substantially complete; and
an oxidizing agent in contact with the reactor, the oxidizing agent selected from a group consisting of a hypohalite donor, dioxirane donor, halo-amine donor, percarboxylic acid donor, chlorine dioxide donor, persulfate(s), and a hydrogen peroxide donor.

43. A composition for bleaching materials, the composition comprising:
a reactor having pores, wherein the reactor includes:
a core that generates N-halo-amine when contacted by a main solvent, the core being 10-80 wt. % oxidizer reactant, 0.5-10 wt. % halogen donor, 0.5-30 wt. % N-hydrogen-donor, 0-30 wt. % binder, 0-30 wt. % pH buffer, and 0-50 wt. % filler; and
a reactor wall surrounding the core and controlling diffusion of the main solvent to the core through the pores, wherein the reactor wall has a substantially lower solubility in the main solvent than the oxidizer reactant and N-halo-amine such that the reactor wall remains substantially intact until generation of the N-halo-amine is substantially complete; and
an oxidizing agent in contact with the main solvent, the oxidizing agent selected from a group consisting of a hypohalite donor, dioxirane donor, hydroxyl radical donor, percarboxylic acid donor, chlorine dioxide donor, persulfate(s), and a hydrogen peroxide donor.

44. The composition of claim 43, wherein a portion of the oxidizer reactant reacts is consumed to generate the N-halo-amine and residual oxidizer reactant forms the oxidizing agent.

45. The composition of claim 43, wherein the oxidizing agent diffuses out of the reactor oxidizer product the pores in the reactor wall.

46. The composition of claim 43, wherein substantially all of the oxidizing agent is present outside the reactor.

47. The composition of claim 43, wherein the reactor wall is a porous membrane.

48. The composition of claim 43, wherein the reactor further comprises a layer of protective coating around the core, the layer comprising at least one of a silicate, cellulose, chitin, chitosan, polymaleic acid, polyacrylic acid, polyacrylamindes, polyvinylalcohols, polyethylene glycols, and their surrogates.

49. The composition of claim 48, wherein the layer is applied between the core and the reactor wall.

50. The composition of claim 48, wherein the layer is applied around the reactor wall.

51. The composition of claim 43, wherein the reactor wall is a first reactor wall surrounding a first reactor space, the reactor further comprising a second reactor wall formed around the first reactor wall and surrounding a second reactor space, such that the N-halo-amine is generated in the first reactor space and the oxidizing agent is generated in the second reactor space.

52. The composition of claim 43, wherein the reactor wall surrounds a reactor space, and wherein the reactor space has a pH level below 7.

53. A composition for bleaching materials, the composition comprising:
a first reactor that generates a first oxidizer product when contacted by a main solvent, the first reactor including a first reactant surrounded by a first reactor wall, the first reactor wall allowing a main solvent to permeate into the first reactor and cause the first reactant to generate the first oxidizer product; and
a second reactor physically mixed with the first reactor, wherein the second reactor generates a second oxidizer product when contacted by the main solvent, the second reactor including a second reactant surrounded by a second reactor wall, the second reactor wall allowing the main solvent to permeate into the second reactor and cause the second reactant to generate the second oxidizer product.

54. A composition for bleaching materials, the composition comprising:
a reactor having pores, wherein the reactor includes:
a core that generates N-halo-amine when contacted by a main solvent, the core being 10-80 wt. % oxidizer reactant, 0.5-10 wt. % halogen donor, 0.5-30 wt. % N-hydrogen-donor, 0-30 wt. % binder, 0-30 wt. % pH buffer, and 0-50 wt. % filler; and
a reactor wall surrounding the core and controlling diffusion of the main solvent to the core through the pores, wherein the reactor wall has a substantially lower solubility in the main solvent than the reactants and the N-halo-amine such that the reactor wall remains substantially intact until generation of the N-halo-amine is substantially complete; and
an oxidizing agent in contact with the reactor, the oxidizing agent selected from a group consisting of a hypohalite donor, dioxirane donor, hydroxyl radical donor, percarboxylic acid donor, chlorine dioxide donor, persulfate(s), and a hydrogen peroxide donor.

55. A kit comprising reactors and instructions for using the reactors in combination with an oxidizing agent, wherein the reactor includes:
a core containing an oxidizer reactant that generates one or more oxidizer product when contacted by a main solvent; and
a reactor wall surrounding the core and controlling diffusion of the main solvent to the core through the pores, wherein the reactor wall has substantially lower solubility in the main solvent than the oxidizer reactant and the oxidizer product such that the reactor wall remains substantially intact until generation of the oxidizer product is substantially complete.

56. The kit of claim 55, wherein the oxidizer product is selected from a group consisting of dioxirane, percarboxylic acid, chlorine dioxide, hydroxyl radicals, hypohalites, and N-halo-amine.

57. A kit comprising an oxidizing agent and instructions for using the oxidizing agent in combination with reactors, wherein each of the reactors includes:
a core containing an oxidizer reactant that generates one or more oxidizer product when contacted by a main solvent; and
a reactor wall surrounding the core and controlling diffusion of the main solvent to the core through the pores, wherein the reactor wall has substantially lower solubility in the main solvent than the oxidizer reactant and the oxidizer product such that the reactor wall remains substantially intact until generation of the oxidizer product is substantially complete.

58. The kit of claim 57, wherein the oxidizer product is selected from a group consisting of dioxirane, percarboxylic acid, chlorine dioxide, hydroxyl radicals, hypohalites, and N-halo-amine.

59. A kit comprising an oxidizing agent, reactors, and instructions for using the oxidizing agent with the reactors to achieve bleaching, wherein each of the reactors includes:
a core containing an oxidizer reactant that generates one or more oxidizer product when contacted by a main solvent; and
a reactor wall surrounding the core and controlling diffusion of the main solvent to the core through the pores, wherein the reactor wall has substantially lower solubility in the main solvent than the oxidizer reactant and the oxidizer product such that the reactor wall remains substantially intact until generation of the oxidizer product is substantially complete;
and wherein the oxidizer product is different from the oxidizing agent.

60. A method of bleaching a material, the method comprising:
contacting a reactor and an oxidizing agent with a main solvent to form a bleach solution, wherein the reactor generates an oxidizer product that is different from the oxidizing agent, and wherein the oxidizer product has a different order of selectivity from the oxidizing agent; and
placing the bleach solution in contact with the material;
wherein the oxidizer product is at least one of dioxirane, hydroxyl radical, peroxyacid, chlorine dioxide, and N-halo-amine, and the oxidizing agent is at least one of dioxirane, hydroxyl radical, N-halo-amine, hypohalite, chlorine dioxide and peroxyacid compound.

61. The method of claim 60, wherein contacting the reactor and the oxidizing agent with the body of solvent comprises adding the reactor and the oxidizing agent to the main solvent.

62. The method of claim 61, wherein the reactor and the oxidizing agent are added to the main solvent simultaneously.

63. The method of claim 60, wherein the reactor comprises:
a core including reactants for generating the oxidizer product; and
a reactor wall around the core, the reactor wall allowing the main solvent to contact the core at a controlled rate and maintaining integrity until generation of the oxidizer product inside the reactor is substantially complete.

64. The method of claim 60 further comprising placing the oxidizing agent inside the reactor in an amount such that a portion of the oxidizing agent reacts to generate the oxidizer product.

65. The method of claim 60, wherein the reactor is a first reactor, further comprising contacting a second reactor with the main solvent, wherein the second reactor generates the oxidizing agent.

66. The method of claim 60, wherein placing the bleach solution in contact with the material comprises preparing the oxidizer product in the form of a solid, gel, or liquid.

67. The method of claim 60 further comprising adding one or more cleaning agents to the main solvent, wherein the cleaning agents include one or more of surfactants, chelants, dispersants, stabilizers, pH buffers, and brighteners.

68. A method of making a bleaching composition, the method comprising:
forming a reactor that generates an oxidizer product upon contacting a main solvent, wherein the oxidizer product is at least one of dioxirane, hydroxyl radical, peracid, chlorine dioxide and N-halo-amine; and
providing an oxidizing agent to be added to the main solvent, wherein the oxidizer product is different from the oxidizing agent and has a different order of selectivity from the oxidizing agent, and wherein the oxidizing agent is at least one of a dioxirane, hydroxyl radical, N-halo-amine, hypohalite, chlorine dioxide and a peracid compound.

69. The method of claim 68 wherein providing the oxidizing agent comprises including an amount of oxidizing agent in the reactor such that residual oxidizing agent remains after a chemical reaction uses some of the oxidizing agent to generate the oxidizer product.

70. The method of claim 68 further comprising mixing the reactor and the oxidizing agent to form a dry mixture.

71. A method of bleaching a material, the method comprising:
generating an oxidizer product by contacting a first reactor with a main solvent, the oxidizer product being at least one of dioxirane, hydroxyl radical, peracid, chlorine dioxide, and N-halo-amine; and
generating an oxidizing agent by contacting a second reactor with the main solvent, wherein the oxidizing agent is different from the oxidizer product and has a different order of selectivity from the oxidizer product, the oxidizing agent being at least one of a dioxirane, hydroxyl radical, N-halo-amine, hypohalite, chlorine dioxide, and peracid compound.

72. The method of claim 71, wherein contacting the first and the second reactors with the main solvent comprises adding the first reactor and the second reactor to the main solvent.

73. The method of claim 72, wherein the first reactor and the second reactor are added to the main solvent simultaneously.

74. The method of claim 71, wherein the first reactor comprises:
a core including the first reactant; and
a reactor wall around the core, the reactor wall allowing the main solvent to permeate to the core at a controlled rate and maintaining integrity until generation of the oxidizer agent inside the reactor is substantially complete.

75. The method of claim 71, wherein the second reactor comprises:
a core including the first reactant; and
a porous reactor wall around the core, wherein in-situ generation of the oxidizing agent occurs inside an area defined by the porous reactor wall.

76. The method of claim 71, wherein placing the bleach solution in contact with the material comprises preparing the oxidizer product in the form of a solid, gel, or liquid.

77. The method of claim 71 further comprising adding one or more cleaning agents to the main solvent, wherein the cleaning agents include one or more of surfactants, chelants, dispersants, stabilizers, pH buffers, and brighteners.

78. A method of bleaching a material, the method comprising:
generating an oxidizer product by contacting a first reactor with a main solvent, the oxidizer product being at least one of dioxirane, hydroxyl radical, peracid, chlorine dioxide, and N-halo-amine; and
generating an oxidizing agent in the main solvent by contacting a reactant with the main solvent, wherein the oxidizing agent is different from the oxidizer product and has a different order of selectivity from the oxidizer product, the oxidizing agent being at least one of a dioxirane, hydroxyl radical, N-halo-amine, hypohalite, chlorine dioxide, and peracid compound.

79. A method of making a bleaching composition, the method comprising:
forming a reactor that generates an oxidizer product upon contacting a main solvent, wherein the oxidizer product is at least one of dioxirane, hydroxyl radical, peracid, chlorine dioxide and N-halo-amine; and
providing an oxidizing agent to be added to the main solvent, wherein the oxidizer product is different from the oxidizing agent and has a different order of selectivity from the oxidizing agent, and wherein the oxidizing agent is at least one of a dioxirane, hydroxyl radical, N-halo-amine, hypohalite, chlorine dioxide and a peracid compound.

80. The method of claim 79, wherein the reactor is a first reactor, and wherein providing the oxidizing agent comprises forming a second reactor that generates the oxidizing agent, wherein the second reactor contains different reactants than the first reactor.

81. The method of claim 79, wherein providing the oxidizing agent further comprises forming the reactor such that it generates both the oxidizer product and the oxidizing agent.
